(19) United States
(12) Patent Application Publication
(10) Pub. No.: US 2021/0248143 A1
(43) Pub. Date: Aug. 12, 2021

(54) AUTOMATICALLY EXECUTING GRAPHQL QUERIES ON DATABASES

(71) Applicant: Citrix Systems, Inc., Fort Lauderdale, FL (US)

(72) Inventors: Shiv Prasad KHILLAR, Bengaluru (IN); Saifulla SHAIK, Bengaluru (IN); Nagendra TANK, Bengaluru (IN); Pakshal Kumar H DHELARIA, Bengaluru (IN); Shouri Gupta R V, Bengaluru (IN); Subramanian RAMAMURTI, Bengaluru (IN)

(21) Appl. No.: 16/786,032

(22) Filed: Feb. 10, 2020

(51) Int. Cl. G06F 16/2455; G06F 9/54; G06F 16/23; G06F 16/21; G06F 16/2452

(52) U.S. Cl. CPC G06F 16/24556; G06F 9/54; G06F 16/2452; G06F 16/213; G06F 16/2379

(57) ABSTRACT

Described embodiments provide systems and methods for executing one or more operations on a data source using an application programming interface (“API”) query language operations. The system can include a server that can receive a request specifying an API query language operation to execute on a data source having a structured query language (“SQL”) API. The server can identify a schema file for operating the API query language on the data source. The server can translate the API query language operation into an SQL operation using the API query language schema file configured for the data source. The server can transmit the SQL operation to the data source. The server can receive an SQL response to the SQL operation from the data source. The server can generate an API query language response based on the SQL response from the data source in response to the request from the client device.

### FIELD OF THE DISCLOSURE

This application generally relates to automatically translating GraphQL queries into structured query language (“SQL”) queries, based in part on schema files, for execution on one or more data sources. For example, the present technical solution provides systems and methods to receive GraphQL queries, translate the GraphQL queries into SQL queries, access one or more data sources using the SQL queries, and translate the SQL responses into GraphQL responses.

### BACKGROUND

Data sources, for example databases, can be queried via an interface. As different types of data sources are introduced providing increased functionality, it can be challenging to efficiently query, access or utilize the various data sources.

### SUMMARY

This Summary is provided to introduce a selection of concepts in a simplified form that are further described below in the Detailed Description. This Summary is not intended to identify key features or essential features, nor is it intended to limit the scope of the claims included herewith.

This technical solution is generally directed to automatically resolving a GraphQL query into one or more SQL queries. For example, systems and methods of this technical solution can automatically translate one or more GraphQL queries into one or more SQL queries to access a data source, and automatically translate the SQL response received from the data source into one or more GraphQL responses

SQL interfaces can provide customizable operations to access, modify, add, and delete information from one or more data sources, for example a database. Because each database can include its own SQL interface, it can be challenging to access different data sources using a unified interface or endpoint. For example, in a Representational State Transfer (“REST”) application-programming interface (“API”), each data source may use many data access logic modules to correctly serve the SQL query corresponding to the REST API request. In an implementation using GraphQL, there may be a single endpoint which may utilize many GraphQL resolvers, where each GraphQL resolver is developed manually for a particular GraphQL query or mutation. An advantage of a GraphQL implementation over a REST API implementation is a GraphQL query can capture the data used to perform desired actions in a single request. Therefore, it can be advantageous for a platform to resolve automatically GraphQL queries instead of using a manually implemented GraphQL query resolver for each possible GraphQL query or mutation.

At least one aspect of this technical solution is directed to a method of executing an operation on a data source. The method can be performed by one or more processors. The method can include a server receiving, from a client device, a request specifying an API query language operation to execute on a data source. The data source can have a structured query language SQL application-programming interface. The method can include the server identifying a schema file for operation of the API query language on the data source having the SQL API. The method can include the server translating the API query language operation into an SQL operation using the API query language schema file configured for the data source. The method can include the server transmitting the SQL operation to the data source. The method can include the server receiving an API query language response based on the SQL response from the data source. The SQL response can be received responsive to the request from the client device specifying the API query language operation.

In some implementations, the API querying language is a graph query language (“GraphQL”). The method can include the server determining a type of the API query language operation is a query. The method can include the server building, responsive to determining the type of API query language operation is query, multiple clauses based on the API query language schema file to generate the SQL operation. The SQL operation can include at least one of a selection set, a where clause, a group by clause, an order clause, a limit clause, or a having clause. In some implementations, the method can include the server determining the type of the API query language operation is mutation create. The method can include the server identifying an input object and a target table corresponding to the request. The method can include the server generating the SQL operation based on the input object and the target table using one or more extensions in the API query language schema file.

In some implementations, the method can include the server determining the type of the API query language operation is mutation update. The method can include the server identifying an update input and an update condition corresponding to a where clause of the API query language operation to selectively update one or more records of the data source. The method can include the server generating the SQL operation based on the update input, the update condition, and a target table using one or more extensions in the API query language schema file.

In some implementations, the method can include the server determining the type of the API query language operation is mutation delete. The method can include the server identifying a delete condition corresponding to a where clause of the API query language operation to selectively delete one or more records of the data source. The method can include the server generating the SQL operation based on the delete condition and a target table using one or more extensions in the API query language schema file. In some implementations, the method can include the server translating the API query language operation to the SQL operation using clauses of the API query language operation. The API query language operation can include at least one of where, orderBy, groupBy, or limit.

In some implementations, the method can include the server determining the request for the API query language operation. The API query language operation can include an API query language argument that defines an SQL expression. The method can include the server processing the SQL response based on the SQL expression to generate the API query language response. In some implementations, the method can include the server determining the request for the API query language operation. The API query language operation can include a lambda function argument. The lambda function argument can be configured to apply a transformation on a collections of objects stored in the data source. The method can include the server processing the SQL response based on the lambda function argument to generate the API query language response. In some implementations, the method can include the server performing a rollup of the API query language by generating one or more sub-SQL operations for the SQL operation to aggregate data from the data source.

At least one other aspect of this technical solution is directed to a system to execute an operation on a data source. The system can include a server. The server can include one or more processors and memory. The server can receive, from a client device, a request specifying an API query language operation to execute on a data source. The data source can have an SQL application-programming interface. The server can identify a schema file for operation of the API query language on the data source having the SQL API. The server can translate the API query language operation into an SQL operation using the API query language schema file configured for the data source. The server can transmit the SQL operation to the data source. The server can receive an SQL response to the SQL operation from the data source. The server can generate an API query language response based on the SQL response from the data source that is responsive to the request from the client device specifying the API query language operation.

In some implementations, the server can determine a type of the API query language operation is query. The server can create, responsive to determining the type of API query language operation is query, multiple clauses based on the API query language schema file to generate the SQL operation. The SQL operation can include at least one of a selection set, a where clause, a group by clause, an order by clause, a limit clause, or a having clause. In some implementations, the server can determine the type of the API query language operation is mutation create. The server can identify an input object and a target table corresponding to the request. The server can generate the SQL operation based on the input object and the target table using one or more extensions in the API query language schema file.

In some implementations, the server can determine a type of the API query language operation is mutation update. The server can identify an update input and an update condition corresponding to a where clause of the API query language operation to selectively update one or more records of the data source. The server can generate the SQL operation based on the update input, the update condition, and a target table using one or more extensions in the API query language schema file. In some implementations, the server can determine a type of the API query language operation is mutation delete. The server can identify a delete condition corresponding to a where clause of the API query language operation to selectively delete one or more records of the data source. The server can generate the SQL operation based on the delete condition and a target table using one or more extensions in the API query language schema file. In some implementations, the API query schema file can define a dialect or a domain-specific language of the data source.

In some implementations, the server can translate the API query language operation to the SQL operation using clauses of the API query language operation. The clauses of the API query language operation can include at least one of where, orderBy, groupBy, or limit. The server can process the SQL response based on the SQL expression to generate the API query language response.

At least one other aspect of this technical solution is directed to a non-transitory computer readable medium storing program instructions for causing one or more processors to carry out one or more actions described herein. The program instructions can cause the one or more processors to receive, from a client device, a request specifying an API query language operation to execute on a data source having an SQL application programming interface. The program instructions can cause the one or more processors to identify a schema file for operation of the API query language on the data source having the SQL API. The program instructions can cause the one or more processors to translate the API query language operation into an SQL operation using the API query language schema file configured for the data source. The program instructions can cause the one or more processors to transmit the SQL operation to the data source. The program instructions can cause the one or more processors to receive an SQL response to the SQL operation from the data source. The program instructions can cause the one or more processors to generate an API query language response based on the SQL response from the data source that is responsive to the request from the client device specifying the API query language operation.

In some implementations, the program instructions can cause the one or more processors to determine a type of the API query language operation is query. The program instructions can cause the one or more processors to create, responsive to determining the type of API query language operation is query, multiple clauses based on the API query language schema file to generate the SQL operation. The SQL operation can include at least one of a selection set, a where clause, a group by clause, an order by clause, a limit clause, or a having clause.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2 depicts an example block diagram of a system for executing an operation on a data source;

FIG. 3 depicts an example implementation of an interface for executing operations on one or more data sources;

FIGS. 4A-B depict an example flow diagram of a method for resolving an SQL query from a GraphQL query;

FIG. 5 depicts an example flow diagram of a method for resolving one or more sub-queries into an SQL query; and

FIG. 6 depicts an example flow diagram of a method for transforming functions and expressions in a GraphQL query.

### DETAILED DESCRIPTION

For purposes of reading the description of the various embodiments below, the following descriptions of the sections of the specification and their respective contents may be helpful:

This technical solution is directed to systems and methods for executing operations on one or more data sources. Due to the increasing demand for flexibility of accessing data, and increase in complexity of SQL queries when accessing large data sources, it can be challenging to perform operations on one or more data sources to access, insert, modify, or delete data. Each SQL query operation uses many endpoints to satisfy the API requests from the client, and each endpoint may include many data access logic modules to correctly serve an SQL query that corresponds to the request. This can result in redundant storage of duplicate code, and increase overall computational complexity while resolving the queries due to the many data access logic modules used. Having many data access logic modules to correctly serve an SQL query can increase the likelihood of a software fault, because each data access logic module may conflict in an unanticipated or undesired manner while processing an API request.

For example, certain graph query language (“GraphQL”) processing implementations may use data processing logic for each possible type of GraphQL query. This can cause excess use of storage space and redundant coding, because each data processing logic is implemented and stored to process each different type of GraphQL query. Furthermore, specific data processing logic can be used for each possible GraphQL mutation request, which can cause additional computational complexity and storage space. The system can make additional requests and parsing steps to determine which of the data processing logic modules should process the GraphQL query into an SQL query, which can result in wasted computational resources.

The systems and methods of this technical solution can provide a general GraphQL query parsing module, without specific data processing logic modules for each possible GraphQL query or GraphQL mutation. This technical solution provides an extendable general GraphQL resolver that can run on a single endpoint. The GraphQL resolver can resolve any kind of GraphQL query or mutation, including create mutations, update mutations, deletion mutations, and GraphQL queries. The technical solution can dynamically translate one or more GraphQL queries, which can include a number of sub-queries, into an SQL queries specific to the accessed data source. The systems and methods of this technical solution can access and utilize a schema file that corresponds to a particular data source to translate one or more GraphQL queries into one or more SQL queries for that data source, and translate the SQL responses received from the data source into GraphQL responses. Accordingly, this technical solution provides an improvement to the computational effort and storage utilization of GraphQL processing systems by reducing the overall code to be executed per GraphQL query, and reducing the overall storage requirements from many data processing logics of other implementations to a single schema file for a particular data source.

Section A describes a computing environment which may be useful for practicing embodiments described herein; and

Section B describes systems and methods for translating an API query language operation to one or more SQL operations.

### A. Computing Environment

Prior to discussing the specifics of embodiments of the systems and methods of an appliance and/or client, it may be helpful to discuss the computing environments in which such embodiments may be deployed.

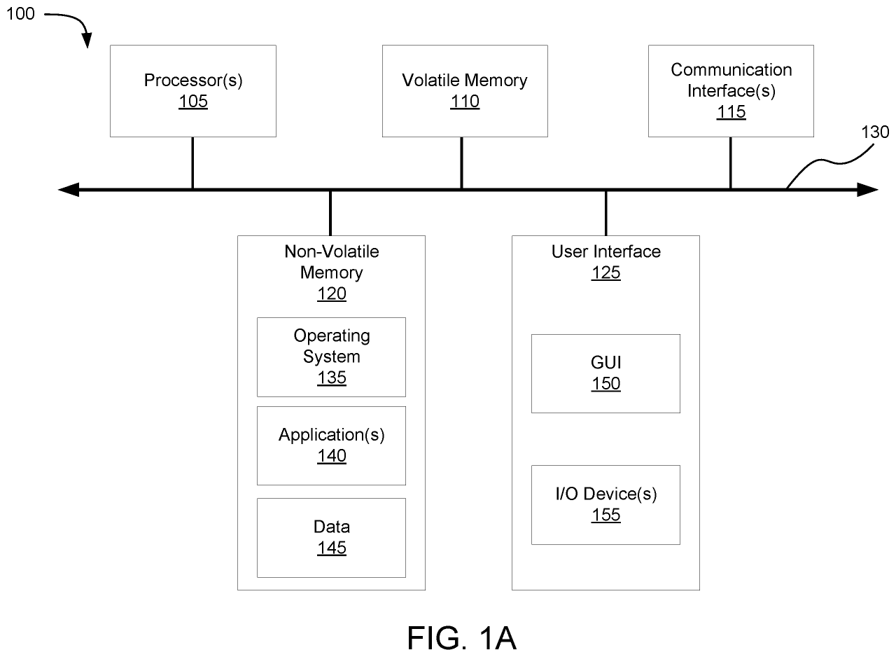

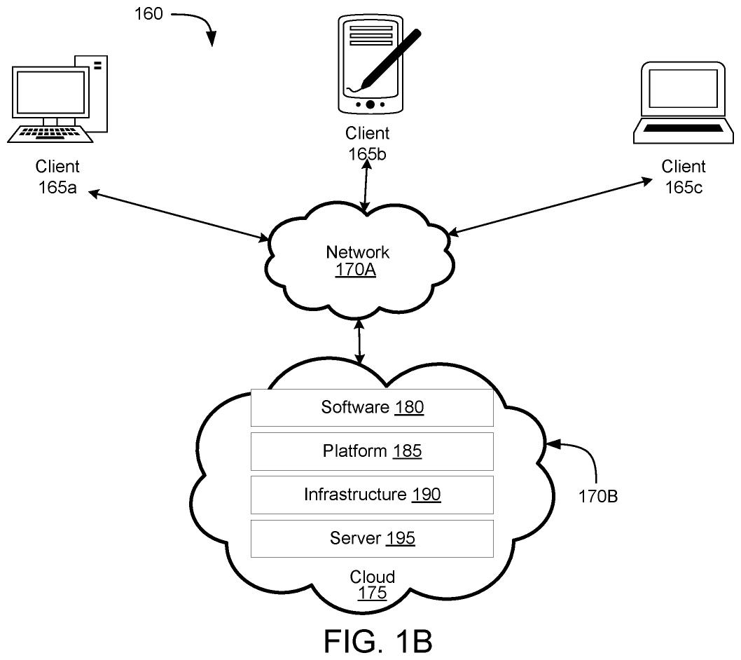

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 160 may include one or more clients 165a-165n, in communication with a cloud 175 over one or more networks 170A, 170B. Clients 165 may include, e.g., thick clients, thin clients, and zero clients. The cloud 175 may include back end platforms, e.g., servers 195, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to the clients 165 or the owners of the clients 165. The servers 195 may be located off-site in remote geographical locations as disclosed above or otherwise. Public clouds 175 may be connected to the servers 195 over a public network 170. Private clouds 175 may include private servers 195 that are physically maintained by clients 165 or owners of clients 165. Private clouds 175 may be connected to the servers 195 over a private network 170. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Translating API Query Language Operations to SQL Operations

This technical solution is directed towards systems and methods for executing one or more operations on a data source by translating API query language operations into SQL operations using a schema file. The schema file can provide, for example, instructions and parameters to translate automatically operations in an API query language into SQL operations for a particular data source, and translate the SQL responses from the data source into corresponding API query language responses.

The system can include a server, which can receive a request specifying an API query language operation to execute on a data source, and identify a schema file for the operation of the API query language on the data source. The identified schema file can include, for example, instructions or parameters that can facilitate the conversion of the API querying language operation to an operation using the SQL API used by the data source indicated in the request. The system can translate the API query language operation into an SQL operation using the schema file configured for the data source, and transmit the translated SQL operation to the data source for processing. The system can receive an SQL response to the transmitted SQL operation from the data source, and generate an API query language response based on the SQL response from the data source.

At least one advantage of this technical solution over other implementations is that the server stores and executes the general API query language translator based on the identified schema file. Instead of storing and executing various data access logic for each possible operation included in the API query language, the systems and methods of this technical solution provide a general API query language resolver which can generate specific data access logic for a particular implementation. In this way, the system can forgo utilizing unnecessary storage space to store data access logic for each possible API query language operation. Furthermore, the system need not execute additional code to determine which of the data access logics processes a particular API query language operation, and instead the system can utilize a schema file that specifies only the particular conversions and SQL operations needed to access the specified data source. This results in an overall reduction in computational complexity and an improvement in computational performance when compared to other implementations that utilize data access logic for each possible API query language operation.

In order to access a data source that operates using an SQL API, an API query operation (e.g., a GraphQL query) can be resolved to a certain SQL query to execute and fetch a response from the data source. Automating the process of resolving API query operations to SQL queries for specific data sources provides an improvement to computational efficiency and storage requirements when compared to other implementations. The systems and methods of this technical solution can provide this automation by adding different clauses to the API query operation, and generating SQL query using domain specific languages (“DSL”) and database dialects, for example a accessed via a schema file.

The systems and methods of this technical solution can automate generating an SQL query to fetch desired data by using enhanced API querying operations, for example GraphQL queries and GraphQL mutations. The systems and methods can provide dynamic filtering, aggregating, ordering, and limiting capabilities automatically, while being completely controlled by a client. The client can define advanced aggregation capabilities that can be automatically translated into an SQL query. Using domain specific languages and dialects, the systems and methods of this technical solution can automatically generate queries from API query operations which are compatible with any specified target database. Furthermore, this technical solution provides an abstraction layer that disassociates analytics offerings from an underlying analytics platform by abstracting away data source specific queries using a high-level API query operations (e.g., GraphQL).

For example, a data analytics platform can display different analytics data in the form of timelines, reports, and charts, among others. The data analytics platform can be controlled using an API, for example a REST API, and can include many endpoints and corresponding data access objects (“DAO”). However, an API querying operation, such as GraphQL, can provide performance improvements when compared to implementations in REST API. Some API querying operations, for example GraphQL, can provide additional filtering capabilities that are not present on an implementation using REST API. The systems and methods of this technical solution can provide an abstract DAO (e.g., a GraphQL query resolver) that can be implemented using a single endpoint, to generate abstract SQL queries for specified data sources. This can allow different teams to seamlessly integrate and create rich information dashboards from multiple underlying data sources by using API query operations (e.g., GraphQL queries and mutations) and the automatic API query resolver.

The API query resolver provided by this technical solution can service any application or interface that has data fetching features based on filters or conditions, such as applications that invoke different requests based on conditions. The API query resolver can be used to automatically generate SQL for an API query operation (e.g., GraphQL query, GraphQL mutation, etc.) with different clauses, depending on conditions and filters selected by the client to select the exact API query response. Furthermore, the systems and methods of this technical solution can implement an abstraction layer between analytics applications and the underlying data stores that are accessed by analytics applications, and translate API query language schema (e.g., GraphQL schema) to schema for each underlying data store schema, while supporting rich querying capabilities. The API query resolver provided by this technical solution can support “group by,” “having,” and “aggregation” functions, and therefore supports flexible functionalities to support fetching data for a variety of applications and environments. The API query resolver further supports data transformations, for example aggregating all events on a particular day or week, as well as normal data aggregation based on a timestamp. By separating the query generation and query execution interfaces, the API query resolver of this technical solution provides the flexibility to execute one or more queries on different data sources, for example a relational database management system (“RDBMS”), or a NoSQL data source. Accordingly, the systems and methods provided by this technical solution significantly reduce the amount of effort and computational resources used for making data available via API query operations (e.g., GraphQL endpoints). Translation from API query language operations to SQL can be encapsulated in one or more API query language schema files, which can be provided by a team responsible for managing the corresponding data source. By offering layers of abstraction between different data sources and data fetching applications, the systems and methods of the present disclosure provide a technical improvement to the storage requirements and computational complexity used to parse, process, and access data sources using API query language operations. This can provide one or more clients the ability to access a number of different data

The systems and methods of this technical solution can also provide an API query resolver that can process sub-queries of API queries, for example, GraphQL sub-queries. API queries can include roll-up operations, which can allow the system to query a range of data (e.g., over a period of time, or other metric), aggregate the queried data, and apply the aggregated data to another metric. For example, a time roll-up query can aggregate many data points over a larger span of time, and average them over a different (e.g., longer) time period to improve query performance. This can allow many stored data points for a given period of time to be condensed into a single data point representing that time period. Accessing rolled-up data points can improve overall query performance if high-resolution data access is not needed. The systems and methods of this technical solution can provide an automatic API query resolver that can resolve an API query (e.g., a GraphQL query with an indication of roll-up operation) into an SQL query with one or more appropriate sub-queries to facilitate a roll-up operation on a data source.

For example, the systems and methods of this technical solution can perform a time roll-up query using GraphQL by resolving the GraphQL query automatically into an SQL query with an appropriate sub-query. The client can control the query roll-ups using both the GraphQL queries and schema. The systems and methods of this technical solution can provide roll-ups of up to N-levels, where N is specified in the GraphQL query or schema. Filtering can be applied to the rolled-up columns of data, and filtering operations can be specified in the GraphQL queries. Rolling-up data into lower resolution data points can facilitate the display of information when high-resolution presentation is not required, particularly when there are many data points over the accessed time period. For example, in a desktop session display platform, a data analytics interface can create a dashboard of users with different session scores (e.g., excellent, good, not excellent, etc.). In this example, session scores can correspond to the connection quality of a session between a client and a desktop server. To create an analysis dashboard of users of the desktop session display platform with poor connection quality, the systems and methods of this technical solution can perform a query time rollup of session scores on users (e.g., session key and machine name), and filter all users whose session score is not excellent. Accordingly, the query resolver provided by this technical solution can be used to create reports included in customized dashboards using rollup values by aggregating data based on simple API query language operations.

Furthering the above example, included below is an example SQL query including a sub-query to rollup desktop session users with a less than ideal session score.

select * from (select FLOOR(AVG(sessionScore)) as UXSessionScore, userName, sessionStartTime, sessionLaunchStatus, failureReason, machineName sessionKey,count(*) from “xaxd_uxscore_sessions WHERE userName LIKE ‘Akshat’ AND _time BETWEEN TIMESTAMP ‘2019-04-17 03:30:00’ AND TIMESTAMP ‘2019-04-17 04:30:00’ group by (userName, sessionKey, sessionStartTime, machineName, sessionLaunchStatus, failureReason)) as table 1 WHERE UXSessionScore<40

Based on the above SQL query, the sessionScore column of data is rolled-up as UXSessionScore, and filters are applied on the rolled up column to only return users with a score that is less than a threshold value. However, manually creating SQL queries for each possible data request or rollup operation can be time consuming to development teams. Any corresponding change to the organization of the data source is propagated to the corresponding SQL requests, which can introduce unexpected bugs and software faults.

To solve these issues, the API query language resolver provided by this technical solution can pass an aggregation function as a field level argument, and a system field (e.g., record_cnt) can be added to assign a counter metric to one or more fields. Each of these arguments can be introduced in an API query language (e.g., GraphQL) query, and can be automatically resolved by the API query language resolver to create one or more SQL queries for accessing the data source using the specified filters. For example, a GraphQL query can take different clauses as arguments (e.g., where, group by, having, order by, limit, etc.). A client can specify each of these arguments to filter and fetch data from one or more data sources to receive a desired response. After specifying the query, the API query language resolver can parse and resolve these arguments into an SQL query, which can include a sub-query to apply the specified rollup or filtering operations.

To resolve an API query language request into an SQL query with a corresponding sub-query for a rollup, the API query language resolver can accept an API query (e.g., a GraphQL query) that includes a where clause, a group by clause, and a having clause as sub-query arguments. The API query language resolver of this technical solution can alias the API query language sub-query with a label that can logically place the SQL query as a sub query in an outer query. Furthermore, the API query language resolver can include the resolved SQL query as a sub query in the SQL query that is resolved for the outer API query (e.g., the outer GraphQL query). The API query language resolver can add a system field named subQuery with an identifier of subQuery to be added as a sub-query inside the current query. The API query language resolver can determine the inner-most query by finding the query with no subQuery field selected, or that a query has no sub-queries using this same process, based on the type of query. The API query language resolver can generate N-levels of sub-queries by simply resolving the API query (e.g., GraphQL query) sent by the client for a query time roll-up operation. To construct the final SQL query in the expected order, the API query language resolver can use the subQuery field and the alias or label passed as an argument. In this way, the systems and methods of this technical solution can achieve query time roll-ups using an API querying language (e.g., GraphQL).

To illustrate the process of converting a GraphQL query to a corresponding SQL query, listed below is an example GraphQL query including a subQuery field to perform a rollup operation using an aggregate function.

{

sessions: xaxdSessions(where: {sessionScore_gt: 75}) {

sessionScore
username
inQuery(subQuery: “subQuery”)
_{——}typename

}
subQuery: xaxdUsersSubQuery(where: {_{——}time_between:

″2019-05-08T14:30:00+05:30,2019-05-08T15:30:00+05:30″},
groupBy: [userName, sessionKey, machineName]) {

username
sessionKey
machineName
sessionScore(aggregateFunc: TRUNC_AVG)
_{——}typename

}

}

Furthering this example, included below is an example representation of a translated SQL query based on the GraphQL query described above.

select sessionScore as “sessionScore”, userName as “userName” from (select userName as “userName”, sessionKey as “sessionKey”, machineName as “machineName”, avg(sessionScore) as “sessionScore” from xaxd_uxscore_sessions_demodb as “xaxd_uxscore_sessions_demodb” where time between ‘2019-05-08T14:30:00+05:30’ AND ‘2019-05-08T15:30:00+05:30’ group by userName, sessionKey, machineName) as “subQuery” where sessionScore>75

In another example, the GraphQL query included below and its corresponding SQL translation include only a specified range of values, to retrieve user outliers who have a session score greater than 70 but all its average less than 75.

{

sessions: xaxdSessions(where: {sessionScore_lt: 75}) {

sessionScore
username
inQuery(subQuery: “subQuery”)
_{——}typename

}
subQuery: xaxdUsersSubQuery(where: {_{——}time_between:

″2019-05-08T14:30:00+05:30,2019-05-08T15:30:00+05:30″},
groupBy: [userName, sessionKey, machineName], having
{sessionScore_gt: 70}) {

username
sessionKey
machineName
sessionScore(aggregateFunc: TRUNC_AVG)
_{——}typename

}

}

Included below is an example representation of a translated SQL query based on the GraphQL query described above.

select sessionScore as “sessionScore”, userName as “userName” from (select userName as “userName”, sessionKey as “sessionKey”, machineName as “machineName”, avg(sessionScore) as “sessionScore” from xaxd_uxscore_sessions_demodb as “xaxd_uxscore_sessions_demodb” where time between ‘2019-05-08T14:30:00+05:30’ AND ‘2019-05-08T15:30:00+05:30’ group by userName, sessionKey, machineName having sessionScore>70) as “subQuery” where sessionScore<75

The systems and methods of this technical solution can resolve sub-queries present in API query language operations to provide functionalities to any application that fetches data from a data source (e.g., a database) and performs data aggregation or query time roll-ups. Resolving sub-queries to aggregate and roll-up data can allow data analytics applications to achieve complex metrics calculations using high level API query language operations, such as calculating aggregations on time-series data across nested time intervals, and other dimensions of a similar nature.

The systems and methods of this technical solution can apply custom logic to transform data based on requests from clients and API query language operations. For example, an API query language operation may fetch data from a data source, but the fetched data may be transformed before the requesting client can utilize it. To solve this issue, the systems and methods of this technical solution can apply one or more transformations to the data, including user-defined functions, lambda functions, or SQL expressions on the response received from the data source. The user-defined functions can include formatting or data transformations to fulfill one or more requirements, for example data processing or user interface generation. Lambda functions can be applied to the data received from the data source as a transformation, and can be defined by an API query language client (e.g., a GraphQL client). Using API query language SQL expression descriptors, the systems and methods of this technical solution can transform the record sets at a specified data source to meet one or more requirements. This technical solution provides an improvement over other implementations that implement custom, static logic to transform data source responses. Specifically, this technical solution reduces the overall storage requirements for redundant data transformation code, reduces overall computational requirements by eliminating testing requirements when changes are made to a data source or its transformations, and eliminates additional errors introduced by additional custom, static logic to transform data from different data sources.

For example, a performance analytics can return session scores for one or more client devices connected to a server. Each session score can correspond to the connection quality between the client device and the server. To better visualize the data, the systems and methods of this technical solution can transform the data by transforming each of the session scores into one of three categories: “poor,” “fair,” and “excellent,” depending on the value of each session score. The systems and methods of this technical solution can perform these functions, and also support advanced transformation features such as user-defined transformation functions and lambda function based transformations.

To provide this technical improvement, the systems and methods of this technical solution can resolve API query language operations that include one or more transformation functions. The systems and methods can apply these transformation functions after executing the query and receiving the response from the data source. The transformation functions can be applied before sending the response to the requesting client. To support API query language SQL expressions, the systems and methods of this technical solution can accept an API query language argument (e.g., a GraphQL argument) that captures the description of an SQL expression. An example GraphQL input for an SQL expression is included below.

input Field {

_type: FieldType!
_column: String
_columnObj: JSON
_case: SqlCase
_function: Function
_alias: String
_div: [Field]
_mul: [Field]
_sub: [Field]
_add: [Field]

}

The SQL Expressions included in the API query language operations can support all of the SQL functions that the underlying data source (e.g., database) can support. The API query language resolver of this technical solution can support one or more lambda functions to apply transformations on one or more collections of objects received from a data source. For example, the objects or data may be mapped into custom columns, or other operations that are not supported by the data source as an SQL function. The API query language resolver can accept lambda functions as an argument to a query (e.g., an argument in a GraphQL query). An example of an input lambda function for a GraphQL query is included below.

input Lambda {

parameters: [String]
function: [Field]

}

The systems and methods of this technical solution can provide functions for transformations that perform operations not supported by lambda functions or SQL expressions. For example, record sets received from a data source can employ a series of transformations in correlation with side inputs, or may include other complex computations or functional steps that are not suited or supported by an SQL expression or a lambda function. In such scenarios, the systems and methods of this technical solution can include one or more user-defined functions as a part of the API query language request (e.g., the GraphQL query). An example of a GraphQL query that includes a user-defined function to create a custom data column organization is included below.

{

xaxdSessions(where: {sessionScoreCustom: “Poor”},

groupBy:[userName,sessionScoreCustom] ,customColumnBuilders: {_field: {_type: String,
_alias: “sessionScoreCustom”, _case: {_when: [{_condition: {_and: [{_ge: {_field: {_type:
Float, _column: “sessionScore”}, _value: 1}}, {_lt: {_field: {_type: Float, _column:
“sessionScore”}, _value: 40}}]}, _then: {_type: String, _function: {_name: trim, _field: {_type:
String, _columnObj: “Poor”}}}}]}}}) {

sessionScoreCustom
username
sessionScore(aggregateFunc: MAX)

}

}

An example of a translated SQL query based on the above GraphQL query is included below.

select sessionScoreCustom “sessionScoreCustom”, userName as “userName”, max(sessionScore) as “sessionScore” from (select *, ease when (sessionScore>=1.0 and sessionScore<40.0) then trim(‘Poor’) end as “sessionScoreCustom” from xaxd_uxscore_ [symbol] ) as “xaxd_uxscore_ [symbol] ” where lower(sessionScoreCustom) ‘poor’ group by userName, sessionScoreCustom limit 10

An example of the corresponding GraphQL response, which is processed by the API query language resolver provided by this technical solution based on the GraphQL query, is included below.

{

“data”: {

“xaxdSessions”: [

{

“sessionScoreCustom”: “Poor”,
“userName”: “Ahmad Cleek”,
“sessionScore”: 39

},
{

“sessionScoreCustom”: “Poor”,
“userName”: “America Schoenborn”,
“sessionScore”: 39

},
{

“sessionScoreCustom”: “Poor”,
“userName”: “Anamaria Meuser”,
“sessionScore”: 39

}

]

}

}

In this way, the systems and methods of this technical solution can provide a system that can leverage and extend the power of API querying languages by applying user-defined transformations in the form of SQL expressions, lambda functions, and user-defined functions. Such functionality may be utilized, for example, by a performance analytics web application, which can access and transform data from a variety of data sources. This functionality may also be used when an API query language request cannot be fulfilled simply by generating an SQL query for an underlying data source, and further transformations are required. The transformations can include, for example, transforming a numerical value into a string value, such as placing an age value into the bins of “child,” “adult,” and “old.” The systems and methods of this technical solution can support advanced transformations by using SQL expressions and fetching transformed data by execution of the query itself.

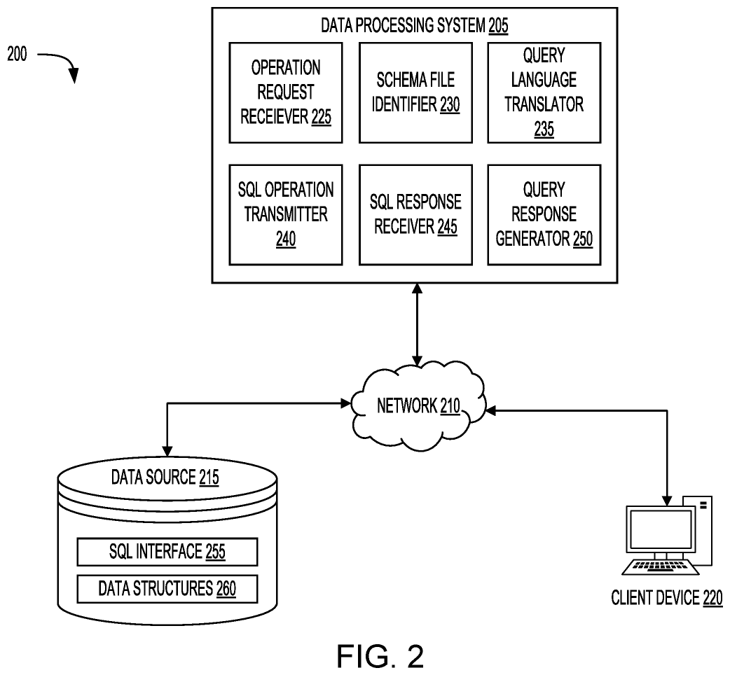

Referring to FIG. 2, depicted is a block diagram of an example system 200 for executing an operation on a data source. The system 200 can include at least one data processing system 205, at least one network 210, at least one data source 215, and at least one client device 220. The data processing system 205 can include at least one operation request receiver 225. The data processing system 205 can include at least one schema file identifier 230. The data processing system 205 can include at least one query language translator 235. The data processing system 205 can include at least one SQL operation transmitter 240. The data processing system 205 can include at least one SQL response receiver 245. The data processing system 205 can include at least one query response generator 250.

Each of the above-mentioned elements or entities is implemented in hardware, or a combination of hardware and software, in one or more embodiments. Each component of the system 200 may be implemented using hardware or a combination of hardware or software detailed above in connection with FIGS. 1A-1B. For instance, each of these elements or entities can include any application, program, library, script, task, service, process or any type and form of executable instructions executing on hardware of a client device 220, or on a data processing system 205. The hardware includes circuitry such as one or more processors in one or more implementations.

The network 210 can include computer networks such as the Internet, local, wide, metro or other area networks, intranets, satellite networks, other computer networks such as voice or data mobile phone communication networks, and combinations thereof. The network 210 can include one or more component or functionality of network 170A depicted in FIG. 1B. The data processing system 205 of the system 200 can communicate via the network 210, for instance with at least one client device 220 and at least one data source 215. The network 210 may be any form of computer network that relays information between the client device 220, data processing system 205, and one or more data sources, such as the data source 215, web servers, databases, amongst others. In some implementations, the network 210 may include the Internet or other types of data networks, such as a local area network (LAN), a wide area network (WAN), a cellular network, a satellite network, or other types of data networks. The network 210 may also include any number of computing devices (e.g., computers, servers, routers, network switches, etc.) that are configured to receive or transmit data within the network 210. The network 210 may further include any number of hardwired or wireless connections. The client device 220 may communicate wirelessly (e.g., via WiFi, cellular, radio, etc.) with a transceiver that is hardwired (e.g., via a fiber optic cable, a CAT5 cable, etc.) to other computing devices in the network 210. The client device 220 may also communicate wirelessly with the computing devices of the network 210 via a proxy device (e.g., a router, network switch, or gateway).

The data processing system 205 can include at least one processor and a memory, e.g., a processing circuit. The memory stores processor-executable instructions that, when executed by processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 205 can include one or more computing devices or servers that can perform various functions as described herein.

The client device 220 can include servers or other computing devices capable of executing one or more applications. The client device 220 may execute one or more applications, for example a web browser, to render and display a web based interface, for example a web page. The client device 220 can execute different scripting languages embedded in web documents, for example JavaScript, HTML, cascading style sheets (CSS), among others. The client device 220 can execute an application that can transmit one or more API query language operations (e.g., GraphQL queries, GraphQL mutations, etc.). For example, the application can be a web application configured to display analytics information based on one or more data structures 260 in the data source 215. The client device 220 can transmit one or more requests based on the information specified by the application to the data processing system 205. In response, the client device 220 can receive one or more API query language operation responses from the data processing system 205. The client device 220 can display the information included in the API query language operation response received from the data processing system 205, for example in the web application. The application of the client device 220 can make a request to the data processing system 205 for each API query language operation individually. In some implementations, the client device 220 can request groups of API query language operations from the data processing system 205 in a batch process, thereby reducing the network utilization of multiple requests, which is an improvement over other implementations.

The data source 215 can include one or more servers or databases, each including at least one processor and a memory, i.e., a processing circuit. The memory stores processor-executable instructions that, when executed by processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data source 215 can include one or more computing devices or servers that can perform various functions as described herein.

The data source 215 can include one or more databases or storage mediums configured to store or maintain any of the information described herein, such as one or more data structures 260 that contain data which can be accessed using the SQL interface 255. In some implementations, the data source 215 can be prepopulated with any predetermined thresholds or other values used performed in conjunction with the operations related to the data processing system 205 or the client device 220. The data processing system 205 can store the results of any or all computations, determinations, selections, identifications, or calculations in one or more data structures 260 in the data source 215. The data processing system 205 can bypass the SQL interface 255 to directly store and access any or all values corresponding to the calculations, determinations, selections, identifications, translations, transmissions, receipts, creations, or generations described herein. The data source 215 can be accessed by any or all of the modules/components of the data processing system 205, the client device 220, or any other external computing devices via the network 210. The data source 215 can receive SQL requests from the data processing system 205 or one of the components of the data processing system 205. The data source 215 can receive requests for other data using any other protocol compatible with any know data source, including but not limited to hypertext transfer protocol (HTTP) requests, file transfer protocol (FTP) requests, peer-to-peer (P2P) requests, and GraphQL requests, among others. The data source 215 can receive such requests from one or more computing devices, for example the data processing system 205 or the client device 220. In some implementations, the data source 215 can be a part of a cloud computing service, for example the cloud 175 depicted in FIG. 1B.

The data source 215 can include one or more SQL interfaces 255, which can provide an interface to access, modify, input, or delete information from the one or more data structures 260. The SQL interface 255 can receive and operate using any SQL commands, functions, or queries, including but not limited to, ALTER TABLE, AND, AS, AVG, BETWEEN, CASE, COUNT, CREATE TABLE, DELETE, FROM, GROUP BY, HAVING, INNER JOIN, INSERT, IS NULL, IS NOT NULL, LIKE, LIMIT, MAX, MIN, OR, ORDER BY, OUTER JOIN, ROUND, SELECT, SELECT DISTINCT, SUM, UPDATE, WHERE, and WITH, among others. The SQL interface 255 can also receive and process one or more custom queries, for example a user-defined query or function. The SQL interface 255 can receive one or more SQL commands, functions, operations, parameters, or queries, and access the data structures 260 accordingly. For example, if the SQL interface 255 receives a SELECT command, followed by one or more parameters, the SQL interface can select and return (e.g., store in another region of memory in the data source 215, transmit to the requesting computing device, etc.) the values in the data structures 260 specified by the command. If no such data exists in the data structures 260, the SQL interface 255 can return one or more error messages, a return message indicating that the request could not be carried out, or a return message that contains no data.

The data source 215 can include one or more data structures 260, which can be accessed via the SQL interface 255, or by other methods as described herein. The data structures 260 can reside in the memory of the data source 215. The data structures 260 can include one or more tables, where each table includes one or more rows and one or more columns. The tables can include one or more identifiers, for example a string name, an identifier value, or an index value indicating the location of the table in memory. The rows and columns of the tables in the data structures 260 can define one or more cells, where each cell can include any type or quantity of data. Such data can include one or more strings, integers, floating point values, double floating point values, quad floating-point values, character values, data objects, additional data structures containing other data values, data tables, lookup tables, and pointers to values in regions of memory in the memory of the data source 215, among others. The data structures 260 can store any of the information provided herein, and such information can be accessed via the SQL interface 255, or by one or more other protocols via the network 210.

The operation request receiver 225 can receive a request from the client device 220 via the network 210. The request can specify an API query language operation to execute on the data source 215, and can include an identifier of the computing device that provided the request, for example the client device 220. The request can include an indication of a schema file corresponding to at least one of the specified data source 215, the type of API query language operation, or the client device 220 identifier. The API query language operation can include one or more scripts, data manipulation operations, data insertion operations, data access operations, retrieval operations, SQL operations, SQL expressions, GraphQL queries, and GraphQL mutations, among others. The API query language operation can be a text file, a binary file, a data structure in a network packet, or any other kind of data transmitted from an external computing device, for example the client device 220. The request can include an indication of a specific data source 215 to access via the network 210, or via the data processing system 205. The operation request receiver 225 can parse the request to determine one or more API query language tokens, for example GraphQL tokens. The tokens can specify, for example, one or more values in the data structures 260 in the data source 215. The operation request receiver 225 can parse the request from the client device 220 to identify one or more SQL expressions, lambda functions, or user-defined functions. The operation request receiver 225 can store the request from the client device 220 in one or more data structures of the data processing system 205. In some implementations, the operation request receiver 225 can transmit the API query language operation to the data source 215. The operation request receiver 225 can parse the request received from the external computing device (e.g., the client device 220) and store it in one or more data structures in the data processing system 205 indexed by an identifier of the external computing device.

The schema file identifier 230 can identify a schema file for operation of the API query language on the data source 215. The schema file can include information about one or more tables in the data structures 260, information about the data structures 260, indications of rows and columns in the data structures 260, indications of the type of data in the data structures 260, and information about the SQL interface 255 of the specified data source 215, among others. The identified schema file can include all information to facilitate the translation of the API query language to one or more SQL expressions for operation on the SQL interface 255 of the data source 215 to access the data structures 260. The schema file can be stored and accessed, for example, in one or more data structures in the memory of the data processing system 205. The schema file identifier 230 can receive schema file from the client device 220. The schema file identifier 230 can identify the schema file based on at least one of one or more indications received in the request from the client device 220, the API query language operation included in the request, the indicated SQL interface 255 of the data source 215, and the data source 215 specified in the request received from the client device 220, among others. For example, the data processing system 205 can store one or more schema files corresponding to a respective data source 215, a respective SQL interface 255, or a respective API query language operation, among others. The schema file identifier 230 can use the information included in the request from the client device 220 to access the one or more data structures in the data processing system 205, and identify the appropriate schema file to satisfy the request received from the client device 220. Accordingly, the identified schema file can be an API query language schema file configured for the specified data source 215.

The schema file identifier 230 can identify one or more dialects or domain-specific languages of the data source 215 from the identified schema file. The one or more dialects can include one or more indications of a type of SQL operation. For example, the one or more dialects can specify a type of SQL language that is compatible with the SQL interface 255 of the data source 215. The one or more dialects can further specify a version of the SQL language type that is compatible with the SQL interface 255 of the data source 215, or any other indications of the type, version, drivers, or other information about compatibility with the SQL interface 255 of the data source 215. The domain-specific languages identified from the schema file identifier can include one or more indicators of an SQL language, for example an SQL language type or version. The domain-specific languages can further include any other language types that may be used to access, modify, insert, delete, or otherwise interact with the data source 215. The domain-specific languages can include languages that are incompatible with the SQL interface 255, but may be used to interact with the data source 215 via another type of communication protocol.

The query language translator 235 can translate the API query language operation into an SQL operation using the identified API query language schema file. The API query language schema file can be configured for the specified data source 215. The query language translator 235 can parse the one or more API query language operations provided in the request received from the client device 220 to determine one or more data operations to perform on the data source 215. Because the data source 215 can be accessed via its corresponding SQL interface 255, the query language translator 235 can create one or more SQL operations compatible with the SQL interface 255 of the specified data source 215 using the determined data operations from the API query language operations. A list of supported SQL operations of the SQL interface 255, along with one or more parameters describing the data stored in the data structures 260 of the data source 215, can be included in the schema file identified by the schema file identifier 230. The query language translator 235 can access the identified schema file to determine the one or more compatible SQL commands, functions, or parameters for the SQL interface, along with parameters and metadata describing the data structures 260, and apply those values to the data operations included in the one or more API query language operations.

Using the commands, parameters, and metadata extracted from the schema file, the query language translator 235 can generate one or more SQL operations that correspond to the data operations included in the one or more API query language operations. For example, if the API query language operation includes instructions (e.g., GraphQL code or instructions) to modify a particular data value in the data structures 260 of the data source 215. The API query language operation can include high-level identifiers of the memory regions of the data structures 260 and the operations to perform on the data in the data structures 260. The query language translator 235 can use the schema file identified by the schema file identifier 230 to map the high-level identifiers in the API query request to low level SQL operations specific to the specified data source 215, and the data structures 260 contained therein. The query language translator 235 can use one or more SQL operation syntax or grammar rules, which can be included in the schema file, to generate one or more SQL operations to carry out the data operations specified in the API query language operation specified in the request received from the client device 220.

The query language translator 235 can parse different types of API query languages, for example GraphQL. The query language translator 235 can parse a GraphQL operation to determine that the GraphQL operation includes, or is, a query. Based on the contents of the GraphQL query, the query language translator 235 can build one or more clauses using the identified schema file to generate the SQL operation for the SQL interface 255 to satisfy the received GraphQL operation. For example, after determining the API query language operation is a query, the query language translator 235 can generate an SQL query to access the data identified in the GraphQL query. The query language translator 235 can use the schema file identified by the schema file identifier 230 to build or create one or more clauses for the SQL query, where each clause can aid in identifying an appropriate region of memory in the data structures 260 of the data source 215 to satisfy the query. The SQL operation or query can include, for example, a selection set, a where clause, a group by clause, an order by clause, a limit clause, or a having clause, among others. The query language translator 235 can identify such clauses in the API query language operation. The clauses in the API query language operation can include where, order by, group by, having, or limit clause, among others.

The query language translator 235 can parse the API query language operation received from the client device 220 to determine that the API query language operation is a mutation create. For example, the mutation create operation can be a GraphQL mutation create operation. Using at least one of the parsed API query language operation and the schema file identified by the schema file identifier 230, the query language translator 235 can identify one or more conditions or memory regions of the data structures 260 of the data source 215 to satisfy the operation. For example, the query language translator 235 can identify an input object corresponding to one or more cells or memory regions in the data structures 260 of a specified data source 215. The input object can be included in the API query language operation, and may define one or more values (e.g., strings, integers, floating-point values, data objects, etc.) that correspond to at least one data structure. The query language translator 235 can identify at least one target table corresponding to the request. The identified target table can represent a location in the data structures 260 of the data source 215 of one or more database tables. Based on the API query language operation, the query language translator 235 can generate an SQL operation corresponding to the SQL interface 255 of the data source 215. The generated SQL operation can be configured to insert the identified input data object into the specified location of the identified target table resident in the one or more data structures 260 of the data source 215. The query language translator 235 can generate the SQL operation to insert the input object using one or more extensions extracted from the schema file identified by the schema file identifier 230.

The query language translator 235 can parse the API query language operation received from the client device 220 to determine that the API query language operation is a mutation update. For example, the mutation update operation can be a GraphQL mutation update operation. Using at least one of the parsed API query language operation and the schema file identified by the schema file identifier 230, the query language translator 235 can identify one or more conditions or memory regions of the data structures 260 of the data source 215 to satisfy the operation. The one or more conditions can be an update condition that can correspond to a WHERE clause in an SQL operation corresponding to the SQL interface 255. The one or more conditions can specify, for example, a region of memory to update in the data structures 260 of the data source 215. The query language translator 235 can parse the API query language operation to identify an update input. The update input can include integers, strings, data objects, and floating-point values, among others, and can correspond to the one or more update conditions identified from the API query language operation. Based on the API query language operation, the query language translator 235 can generate an SQL operation corresponding to the SQL interface 255 of the data source 215. The generated SQL operation can be configured to update the identified update input data in the one or more data structures 260 of the data source 215 based on the one or more identified update conditions, and a target table. The target table can be specified, for example, in the API query language operation, or in the identified schema file. The query language translator 235 can generate the SQL operation to update the target table using one or more extensions extracted from the schema file identified by the schema file identifier 230. Updating the target table can include replacing one or more regions of memory in the data structures 260 with data specified in the API query language operation.

The query language translator 235 can parse the API query language operation received from the client device 220 to determine that the API query language operation is a mutation delete. For example, the mutation delete operation can be a GraphQL mutation delete operation. Using at least one of the parsed API query language operation and the schema file identified by the schema file identifier 230, the query language translator 235 can identify one or more conditions or memory regions of the data structures 260 of the data source 215 to satisfy the operation. The one or more conditions can be a delete condition that can correspond to a WHERE clause in an SQL operation corresponding to the SQL interface 255. The WHERE clause can specify one or more data records to selectively delete from the data structures 260 of the data source 215. The one or more conditions can specify, for example, a region of memory of the data structures 260 of the data source 215 containing one or more data records to delete. The data records can be cells, data objects, or metadata included in the data structures 260 of the data source 215. Based on the API query language operation, the query language translator 235 can generate an SQL operation corresponding to the SQL interface 255 of the data source 215. The generated SQL operation can be configured to selectively delete the data records from the specified by the WHERE clause based on the one or more identified delete conditions, and a target table. The target table can be specified, for example, in the API query language operation, or in the identified schema file. The query language translator 235 can generate the SQL operation to delete one or more data records in the target table using one or more extensions extracted from the schema file identified by the schema file identifier 230. Deleting the data records from the target table can include removing one or more data objects or tables from the data structures 260 of the data source 215.

The query language translator 235 can parse the API query language operation received from the client device 220 to determine that the API query language operation includes a roll-up operation. Roll-up operations can be used to aggregate one or more data records into a single data records based on at least one data range of data, and return the aggregated data to the requesting device. The ranges of data can be columns of data, rows of data, or any other identifier of a data location in the data structures 260 of the data source 215. The query language translator can identify one or more data ranges and any other information used for the roll-up operation by parsing the API query language operation. As a part of the roll-up operation, the API query language operation can include one or more functions to perform to aggregate the data for the roll-up operation. The functions can be user-defined functions, built-in functions, or other functions. For example, the roll-up function can include an indication to average the data records over a particular data range (e.g., a period of time, etc.) periodically. To satisfy the requirements of the roll-up operation specified in the API query language operation, the query language translator can generate one or more sub-queries for the generated SQL operation. The sub-queries can include additional SQL operations that can perform the roll-up operation on the data source 215. The SQL sub-queries can include operations or instructions to aggregate the data indicated by the API query language operation received from the client device 220.

The SQL operation transmitter 240 can transmit, communicate, or otherwise provide the one or more generated SQL operations to the data source 215 to carry out the specified data operations. The SQL operation transmitter 240 can transmit the SQL operations in one or more data packets via the network 210. Transmitting the generated SQL operations can include transmitting one or more SQL sub-queries generated by the query language translator 235, for example to perform roll-up requests. The SQL operation transmitter 240 can transmit the SQL operations or sub-queries to the SQL interface 255, the data structures 260, or the data source 215. Before transmitting the SQL operations or sub-queries, the SQL operation transmitter 240 can store the SQL operations or sub-queries in one or more data structures in the memory of the data processing system 205. Transmitting the SQL operations and sub-queries can include communicating with the SQL interface 255 using one or more communication protocols, for example HTTP, FTP, or other types of communication protocols.

The SQL response receiver 245 can receive an SQL response to the transmitted SQL operations or sub-queries from the data source 215, the SQL interface 255, or the data structures 260. The response received by the SQL response receiver 245 can include one or more data records, or an indication that an operation has been carried out. For example, if the corresponding SQL operation included a create operation, the SQL response received from the data source 215 can include an indication that the creation operation occurred successfully. If the creation operation did not execute successfully, the SQL response can include one or more error messages indicating the operation had failed, and one or more error codes or messages describing why the operation failed. If the corresponding SQL operation included an update operation, the SQL response received from the data source 215 can include an indication that the update operation occurred successfully. If the update operation did not execute successfully, the SQL response can include one or more error messages indicating the operation had failed, and one or more error codes or messages describing why the operation failed. If the corresponding SQL operation included a query operation, the SQL response received from the data source 215 can include one or more in the data structures 260 requested by the query, and an indication that the query operation occurred successfully. If the query operation did not execute successfully, the SQL response can include one or more error messages indicating the operation had failed, and one or more error codes or messages describing why the operation failed. If the corresponding SQL operation included a delete operation, the SQL response received from the data source 215 can include an indication that the delete operation occurred successfully. If the query operation did not execute successfully, the SQL response can include one or more error messages indicating the operation had failed, and one or more error codes or messages describing why the operation failed. The SQL response receiver 245 can store the response, including any data records, indications, error codes, error messages, or error indications in one or more data structures in the memory of the data processing system 205. If the SQL response receiver 245 receives an error code, error message, or error indication, or other indications that an operation did not execute successfully on the data source 215, the SQL response receiver 245 can transmit the error code, error message, or error indication, or other indication to the client device 220.

The SQL response receiver 245 can identify one or more SQL expressions, lambda functions, or user-defined functions in the request for the one or more API query language operations received from the client device 220. The SQL response receiver 245 can determine, for example, that the API query language operation includes an API query language argument that defines an SQL expression. For example, the API query language operation can be a GraphQL query that defines an SQL expression. The SQL response receiver 245 can determine the SQL expression is present in the request by parsing the request for the API query language operations received from the client device 220. The SQL expression can define, for example, one or more transformations to data received from the data source 215. For example, the SQL expression may include instructions to reformat the data received in the SQL response. The SQL response receiver 245 can parse the instructions provided by the SQL expression, and perform one or more actions on the data included in the received SQL response that correspond to the instructions in the SQL expression. In this way, the SQL response receiver 245 can both receive one or more SQL responses, and perform post-processing on the responses to transform the data received from the data source 215. In some implementations, the SQL response receiver 245 can transmit the SQL expression to the SQL interface 255. The SQL interface 255 can then perform the post-processing steps indicated by the instructions provided in SQL expression extracted from the API query language operation. The SQL response receiver 245 can store the results of the SQL expressions applied to the response data in one or more data structures in the memory of the data processing system 205.

The SQL response receiver 245 can identify one or more lambda functions, or user-defined functions, in the one or more API query language operations received from the client device 220. Lambda functions and user-defined functions can include instructions that may be challenging to perform using SQL expressions, such as applying transformations on collections of objects stored in the data source 215. The SQL response receiver 245 can determine, for example, that the API query language operation includes an API query language argument that defines a lambda function or a user-defined function. For example, it can be challenging to map a column of data returned from the data source 215 into one or more custom columns using an SQL expression. Thus, the SQL response receiver 245 can identify and execute instructions specified by one or more lambda functions or user-defined functions included in the API query language operation. The SQL response receiver can execute the instructions, for example, on data included in the SQL response received from the data source 215. Thus, the SQL response receiver 245 can perform post-processing on the data received from the data source 215 in response to one or more SQL operations. The SQL response receiver 245 can store the results of the lambda or user functions in one or more data structures in the memory of the data processing system 205.

The query response generator 250 can generate an API query language response based on the schema file and the SQL response received from the data source 215. The query response generator 250 can parse the response received by the SQL response receiver 245 to determine one or more data records or indications. Based on the data records or indications and the API query language operation received from the client device 220, the query response generator can generate an API query language response that satisfies the API query language operation. For example, if the API query language operation includes a data query operation, the query response generator 250 can generate an API query language response including the requested data in the requested format. The query response generator 250 can include any indications of failure or success of the corresponding API query language operation in the generated API query language response. If the API query language operation includes an SQL expression, lambda function, or user-defined function, the query response generator can access the resulting transformed response processed by the SQL response receiver 245 to generate the API query language response based on the API query language operation. The query response generator 250 can generate the API query language response based on the schema file identified by the schema file identifier 230. After generating the API query language response, the query response generator 250 can store the generated API query language response in one or more data structures in the memory of the data processing system 205. The query response generator 250 can transmit the generated API query language response, including any indications of operational success or failure, to the client device 220.

At least one example implementation of a system for executing operations on a data source can include using a REST API configuration. The system can include at least one REST client, at least one REST controller, at least one data access logic, and at least one data source. The data source can be, for example, the data source 215 described herein above. The REST client can be, for example, the client device 220 described herein above. The REST controller can receive one or more REST API operations from the REST client to access, modify, insert, or delete information in the data source. The REST controller can include servers, or other computing devices as described herein, and can be configured to execute one or more instructions included in REST API requests or responses. Each REST controller can communicate with at least one REST client to receive one or more REST API operations.

Each REST controller can process the REST API operations received from the REST client to determine one or more data access logics to access the data source. The data access logics can correspond to an SQL query or operation that can be used to access the data source. Accordingly, to use a variety of SQL queries in a REST API implementation, the system can include many data access logics, each in communication with the REST controller. Each data access logic can use the information received from the REST controller to access the data source using a particular query. In response, the data source can provide the data access logic with an SQL response. The data access logic can return the data received from the data source in the response to the REST controller, and the REST controller can transmit the data to the REST client. A REST implementation such as system uses many REST controllers for many clients, and many data access logics to serve each of the REST controllers. This can result in redundant code and redundant network requests from the REST client to each REST controller, and from each REST controller to each data access logic.

At least one other example implementation of a system for executing operations on a data source using a GraphQL implementation can include one or more GraphQL query resolvers. The system can include at least one GraphQL client, at least one GraphQL endpoint, at least one GraphQL query resolver, and at least one data source. The GraphQL client can be, for example, the client device 220 described herein above. The data source can be, for example, the data source 215 described herein above. The GraphQL endpoint can receive GraphQL operations from one or more GraphQL clients. If the GraphQL operation received from the GraphQL client is a query, the GraphQL endpoint can determine one or more GraphQL query resolvers that can execute the query. The GraphQL query resolvers can be created manually by one or more development teams, and can include information to translate specific GraphQL queries into SQL operations for execution on the data source.

The GraphQL query resolvers can include GraphQL mutation resolvers, which can be configured to resolve GraphQL mutation operations. Each GraphQL query resolver can be configured to resolve a specific type of GraphQL query into a corresponding SQL query. Based on the content of the GraphQL operation received from the GraphQL client, the GraphQL endpoint can selectively forward GraphQL queries to each of the corresponding GraphQL queries resolvers that can appropriately resolve the operations. The GraphQL query resolvers can resolve the specific GraphQL queries into SQL operations, and access the data source using the SQL operations. The data source can return one or more SQL responses to the GraphQL query resolvers. The GraphQL query resolvers can resolve the SQL responses into GraphQL responses, and forward the GraphQL responses to the GraphQL endpoint. The GraphQL endpoint can aggregate each GraphQL response from each selected GraphQL query resolver to create a complete GraphQL response that includes all of the information requested in the GraphQL operation provided by the GraphQL client. After aggregating all of the GraphQL responses, the GraphQL endpoint can provide the complete GraphQL response to the GraphQL client. This implementation is an improvement over the REST API implementation, because this GraphQL implementation can capture all the data used to fulfill the objective of GraphQL client in a single request to a single endpoint, which reduces the overall number of network transmissions and therefore improves network performance.

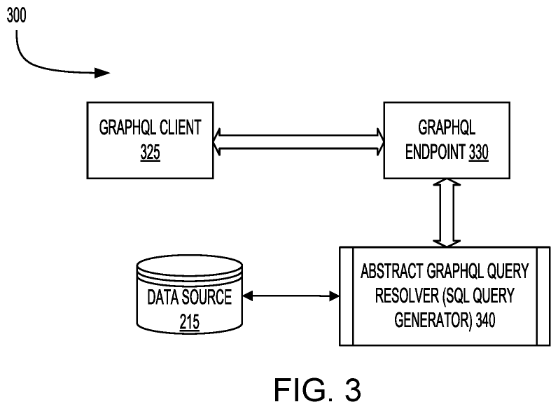

Referring now to FIG. 3, depicted is an example implementation of a system 300 for executing operations on a data source using an abstract GraphQL query resolver to generate SQL queries or operations for the data source 215. The system 300 can be, for example, the system 200 described herein above. The system 300 can include at least one GraphQL client 325, which can be, for example, the client device 220 described herein above in FIG. 2. The system 300 can include at least one GraphQL endpoint 330, which can be, for example, the one or more components of the data processing system 205 described herein above in FIG. 2. The system 300C can include at least one abstract GraphQL query resolver 340 (e.g., an SQL query generator), which can be, for example, one or more of the components of the data processing system 205 described herein above in FIG. 2.

The GraphQL client 325 can transmit one or more GraphQL operations via a network (e.g., the network 210) to the GraphQL endpoint 330. The GraphQL endpoint 330 can receive and parse the one or more GraphQL operations, including any SQL expressions, lambda functions, or user-defined functions. The GraphQL endpoint 330 can provide the parsed GraphQL operations to the abstract GraphQL query resolver 340. The abstract GraphQL query resolver 340 can parse the one or more GraphQL operations (e.g., GraphQL queries and GraphQL mutations) to generate one or more data access logics for SQL operations to access the data source 215. The abstract GraphQL query resolver can provide the generated SQL operations to the data source 215, and receive one or more SQL responses from the data source 215. The abstract GraphQL query resolver 340 can parse each of the SQL responses to generate a GraphQL response that corresponds to the GraphQL request received by the GraphQL client 325. In some implementations, the abstract GraphQL query resolver 340 can forward each of the SQL responses to the GraphQL endpoint, which then generates a GraphQL response that corresponds to the GraphQL request using the SQL responses. The GraphQL endpoint 330 can then transmit, via a network (e.g., the network 210) the GraphQL response to the GraphQL client 325. At least one technical improvement of this implementation is that system 300C does not require individual GraphQL query resolvers created by development teams. Instead, the abstract GraphQL query resolver 340 can generate one or more data access logics (e.g., SQL operations) to access the data source 215. This implementation can reduce the overall storage requirements for each GraphQL query resolver, by instead using a single abstract GraphQL query resolver, and can reduce the computational effort used to access the data source 215 using large, complicated GraphQL requests.

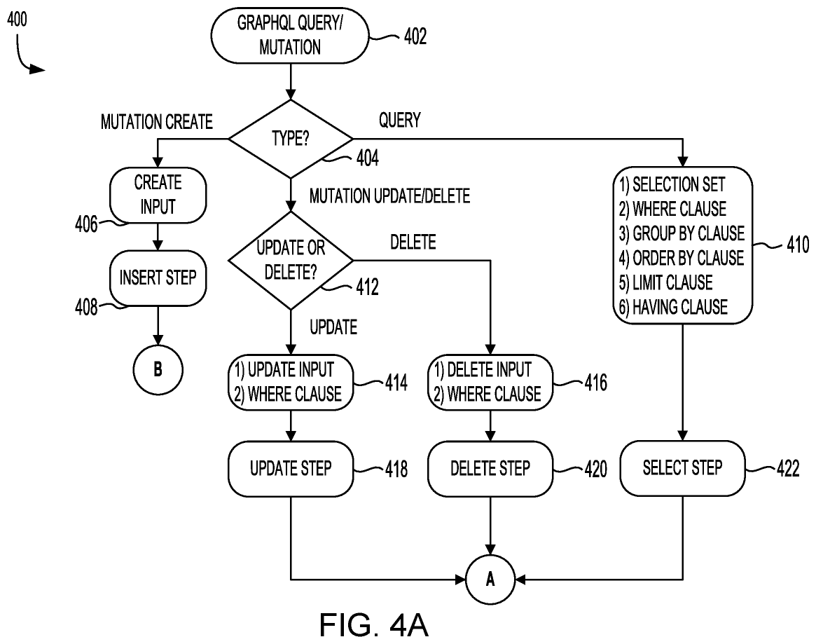

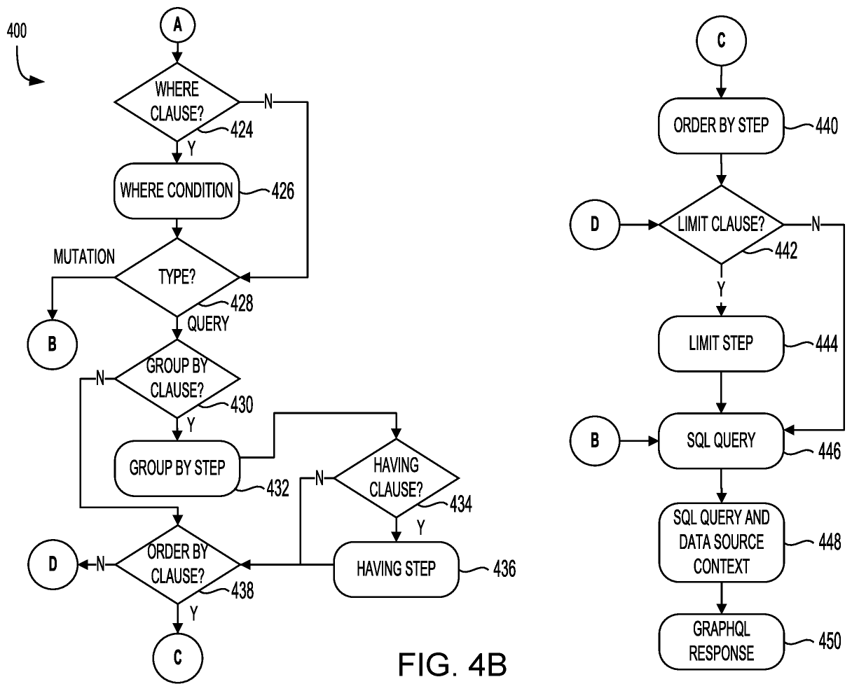

Referring now to FIGS. 4A-B, depicted is a method 400 for resolving an SQL query from a GraphQL query. The method 400 can be performed by one or more system, component, or element depicted in FIG. 1A, 1B, 2, or 3, including, for example, the data processing system 205, the client device 220, the data source 215, or any other computing devices described herein. The server (e.g., the data processing system 205) can receive a GraphQL query or mutation from a client device (ACT 402). The server can determine the type of the GraphQL query or mutation (DECISION 404). The server can identify the input object and target table for the create query (ACT 406). The server can generate an insert query (ACT 408). The server can sequentially enumerate any selection set clauses, where clauses, group by clauses, order by clauses, limit clauses, or having clauses in the GraphQL query (ACT 410). The server can determine whether the GraphQL mutation is a delete mutation or an update mutation (ACT 412). The server can parse the GraphQL mutation to determine the update input and the update condition (ACT 414). The server can parse the GraphQL mutation to determine the delete input and the delete condition (ACT 416). The server can generate the update operation (ACT 418). The server can generate the delete operation (ACT 420). The server can generate the select clause for the query (ACT 422). The server can determine whether to generate a WHERE clause (DECISION 424). The server can generate the WHERE clause (ACT 426). The server can determine whether the GraphQL operation is a mutation or a query (DECISION 428). The server can determine whether to generate a GROUP BY clause (DECISION 430). The server can generate the GROUP BY clause (ACT 432). The server can determine whether to generate a HAVING clause (DECISION 434). The server can generate a HAVING clause (ACT 436). The server can determine whether to generate an ORDER BY clause (DECISION 438). The server can generate the ORDER BY clause (ACT 440). The server can determine whether to generate a LIMIT clause (DECISION 442). The server can generate the LIMIT clause (444). The server can generate the final SQL operation (ACT 446). The server can combine the SQL query with a data source context (ACT 448). The server can generate a GraphQL response (ACT 450).

The server (e.g., the data processing system 205) can receive a GraphQL operation from a client device (e.g., the client device 220) (ACT 402). A GraphQL operation can be included along with a request to access a specific data source (e.g., the data source 215). Based on the indication of the data source, the server can load one or more schema files describing data source context information such as table organization, table names, table metadata, and other information about the data source. The GraphQL query and mutation can include one or more queries, operations, data types, and conditions. The server can store the GraphQL queries or mutations, for example, in one or more data structures in memory for further processing. The server can determine whether the GraphQL operation is valid GraphQL operation (e.g., no syntax errors, no grammar errors, within access thresholds, etc.). If the GraphQL operation is valid, the server can perform ACT 404. If the GraphQL operation is not valid, the server can provide an error indication to the client device.

The server can determine the type of the GraphQL query or mutation (DECISION 404). The server can parse the GraphQL operation received from the client device to determine the type of GraphQL operation. For example, a GraphQL operation can be a query or a mutation. If the GraphQL operation is a query, the server can perform ACT 410. If the GraphQL operation is a mutation, it can be either a creation mutation, a deletion mutation, or an update mutation. If the GraphQL operation is a creation mutation, the server can perform ACT 406. If the GraphQL operation is an update mutation or a delete mutation, the server can perform ACT 412. The server can store the type of GraphQL operation corresponding to the request received by the client device in one or more data structures in the memory of the server.

The server can identify the input object and target table for the create query (ACT 406). GraphQL creation mutations can include an input object (e.g., input data of any kind), and a target table. The server can parse the GraphQL creation mutation to determine the corresponding data object to insert in the data source, and the corresponding table to insert the data source. The server can parse the GraphQL creation mutation to determine a location in the table to insert the identified input object. The server can record, in one or more data structures in the memory of the server, the input object and the table indication corresponding to the GraphQL operation. After determining the input object and the target table, the server can perform ACT 408.

The server can generate an insert query (ACT 408). Based on the insert object and the target table, the server can generate a portion of an insert query operation. The server can generate an SQL operation that encompasses the operations included in the one or more GraphQL queries. The server can generate a final SQL query operation corresponding to the GraphQL operation by generating the insert operation portion of the query, and building upon it with additional clauses in later steps to refine its functionality. Accordingly, at this stage, the server can generate the insert portion of the SQL query operation, and store it in memory for further processing. The SQL query operation can be generated, for example, using at least the input object extracted from the GraphQL operation and an indication of the target table. After generating the insert portion of the SQL operation, the server can perform ACT 446.

The server can sequentially enumerate any selection set clauses, where clauses, group by clauses, order by clauses, limit clauses, or having clauses in the GraphQL query (ACT 410). A GraphQL query can include one or more data lookup operations. To refine these data lookup operations, different clauses can be added to a baseline SQL selection set query. Accordingly, at this stage, the server can parse the GraphQL query and determine which clauses, if any, can be appended to the baseline selection set query to achieve the functionality described in the GraphQL query. After determining this information, the server can execute ACT 422.

The server can determine whether the GraphQL mutation is a delete mutation or an update mutation (ACT 412). GraphQL mutations can manipulate existing data records in one or more locations in the specified data source. The server can parse the GraphQL mutation to determine whether the mutation is a delete mutation, which can delete data records from the data source, or an update mutation, which can update or replace existing records in the data source. If the server determines that the GraphQL mutation is an update mutation, the server can perform ACT 414. If the server determines that the GraphQL mutation is a delete mutation, the server can perform ACT 416.

The server can parse the GraphQL mutation to determine the update input and the update condition (ACT 414). To update a data record in the data source, the server can identify the update input, which represents the new data that can replace the old data. The server can identify an update condition to update the information. The update condition can include a target table, and a target location in the table to update the data records with the update input. The server can identify the update input and the update condition by parsing the GraphQL update mutation. The server can store the identified update input and the identified update condition in one or more data structures in the memory of the server. After identifying the update input and the update condition, the server can perform ACT 418.

The server can parse the GraphQL mutation to determine the delete input and the delete condition (ACT 416). To delete one or more data records in the data source, the server can identify the deletion input, which can include a delete condition. The delete condition can include a target table, and a target location. The target location can be a range of data values, for example, an entire row, column, or data table in the data source. The server can identify the delete input by parsing the GraphQL delete mutation. The server can store the identified delete input in one or more data structures in the memory of the server. After identifying the delete input and the update condition, the server can perform ACT 420.

The server can generate the update operation (ACT 418). Based on the update input and the update condition, the server can generate a portion of an update SQL query operation. The server can generate an SQL operation that encompasses the operations included in the one or more GraphQL queries. The server can generate a final SQL query operation corresponding to the GraphQL operation by generating the update operation portion of the query, and building upon it with additional clauses in later steps to refine its functionality. Accordingly, at this stage, the server can generate the update portion of the SQL query operation, and store it in memory for further processing. The SQL query operation can be generated, for example, using at least the update input and the updated condition extracted from the GraphQL operation. After generating the update portion of the SQL operation, the server can perform ACT 424.

The server can generate the delete operation (ACT 420). The server can generate the update operation (ACT 418). Based on the delete input including the delete condition, the server can generate a portion of a delete SQL query operation. The server can generate an SQL operation that encompasses the operations included in the one or more GraphQL queries. The server can generate a final SQL query operation corresponding to the GraphQL operation by generating the delete operation portion of the query, and building upon it with additional clauses in later steps to refine its functionality. Accordingly, at this stage, the server can generate the delete portion of the SQL query operation, and store it in memory for further processing. The SQL query operation can be generated, for example, using at least the delete input including the delete condition extracted from the GraphQL operation. After generating the delete portion of the SQL operation, the server can perform ACT 424.

The server can generate the select clause for the query (ACT 422). Based on the information extracted from the GraphQL query, the server can generate a select portion of an SQL query operation. The server can generate an SQL operation that encompasses the operations included in the one or more GraphQL queries. The server can generate a final SQL query operation corresponding to the GraphQL operation by generating the select clause portion of the query, and building upon with additional clauses in later steps to refine its functionality. Accordingly, at this stage, the server can generate the select clause of the SQL query operation, and store it in memory for further processing. The SQL query operation can be generated, for example, using at least the information extracted from the GraphQL query. After generating the select clause portion of the SQL operation, the server can perform ACT 424.

The server can determine whether to generate a WHERE clause (DECISION 424). In an SQL operation, the WHERE clause can narrow data manipulation to one or more rows in one or more tables in the data source based on conditions. For example, the WHERE clause can specify a particular target table and a particular row. The WHERE clause can be appended to any SELECT, INSERT, UPDATE, or DELETE SQL statements. In some implementations, a FROM statement paired with a WHERE statement can specify a particular TABLE for an SQL operation. The WHERE clause can also include one or more predicates to narrow the identification of operative data items. To determine whether the specified data source should include a WHERE clause, the server can access the one or more data structures in the memory of the server associated with the GraphQL query. The data structures can include information about one or more conditions associated with the respective GraphQL operation. The server can analyze the conditions present in the data structures (e.g., the update condition, the delete condition, the selection condition, etc.) to determine whether a WHERE clause is needed for the final SQL query. If a condition exists that uses a WHERE clause, the server can perform ACT 426. If no condition exists for the GraphQL operation that uses a WHERE clause, the GraphQL operation can perform ACT 428.

The server can generate the WHERE clause (ACT 426). In an SQL operation, the WHERE clause can narrow data manipulation to one or more rows in one or more tables in the data source based on conditions. For example, the WHERE clause can specify a particular target table and a particular row. The WHERE clause can be appended to any SELECT, INSERT, UPDATE, or DELETE SQL statements. In some implementations, a FROM statement paired with a WHERE statement can specify a particular TABLE for an SQL operation. The WHERE clause can also include one or more predicates to narrow the identification of operative data items. Based on the one or more conditions identified in ACT 424, the server can generate the WHERE clause for the final SQL query. The server can append the WHERE clause to the existing working query (e.g., the UPDATE query from ACT 418, the UPDATE query from ACT 420, or the UPDATE query from ACT 422) to further match the functionality of the original GraphQL operation received from the client device. After appending the WHERE clause to the query, the server can perform DECISION 428.

The server can determine whether the GraphQL operation is a mutation or a query (DECISION 428). The server can parse the GraphQL operation received from the client device to determine the type of GraphQL operation. For example, a GraphQL operation can be a query or a mutation. If the GraphQL operation is a query, the server can perform ACT 430. If the GraphQL operation is a mutation, it can be either a creation mutation, a deletion mutation, or an update mutation. If the GraphQL operation is a creation mutation, the server can perform ACT 446. The server can store the type of GraphQL operation corresponding to the request received by the client device in one or more data structures in the memory of the server.

The server can determine whether to generate a GROUP BY clause (DECISION 430). In an SQL operation, the GROUP BY clause can narrow data manipulation and access by grouping one or more rows in one or more tables in the specified data source. For example, the GROUP BY clause can group one or more result sets (e.g., from an aggregate function) into one or more columns. The GROUP BY clause can be appended to any SELECT, INSERT, UPDATE, or DELETE SQL statements. To determine whether the specified data source should include a GROUP BY clause, the server can access the one or more data structures in the memory of the server associated with the GraphQL query. The data structures can include information about one or more conditions associated with the respective GraphQL operation. The server can analyze the conditions present in the data structures (e.g., the update condition, the delete condition, the selection condition, etc.) to determine whether the GROUP BY clause is needed for the final SQL query. If a condition exists that uses a GROUP BY clause, the server can perform ACT 432. If no condition exists for the GraphQL operation that uses a GROUP BY clause, the GraphQL operation can perform ACT 438.

The server can generate the GROUP BY clause (ACT 432). In an SQL operation, the GROUP BY clause can narrow data manipulation and access by grouping one or more rows in one or more tables in the specified data source. For example, the GROUP BY clause can group one or more result sets (e.g., from an aggregate function) into one or more columns. The GROUP BY clause can be appended to any SELECT, INSERT, UPDATE, or DELETE SQL statements, which may include other clauses appended in previous ACTs. Based on the one or more conditions identified in ACT 430, the server can generate the GROUP BY clause for the final SQL query. The server can append the GROUP BY clause to the existing working query to further match the functionality of the original GraphQL operation received from the client device. After appending the GROUP BY clause to the query, the server can perform DECISION 434.

The server can determine whether to generate a HAVING clause (DECISION 434). In an SQL operation, the HAVING clause can narrow data manipulation to one or more grouped rows (e.g., grouped by GROUP BY) in one or more tables in the data source based on conditions. For example, the HAVING clause can specify one or more conditions to include, access, or modify data. The HAVING clause can be appended to any SELECT, INSERT, UPDATE, or DELETE SQL statements that also include a GROUP BY clause. To determine whether the specified data source should include a HAVING clause, the server can access the one or more data structures in the memory of the server associated with the GraphQL query. The data structures can include information about one or more conditions associated with the respective GraphQL operation. The server can analyze the conditions present in the data structures (e.g., the update condition, the delete condition, the selection condition, etc.) to determine whether the GROUP BY clause is to be used for the final SQL query. The server can further parse and analyze the corresponding GraphQL operation to determine if there are any other conditions present that use a HAVING clause. If a condition exists that uses a HAVING clause, the server can perform ACT 436. If no condition exists for the GraphQL operation that uses a HAVING clause, the GraphQL operation can perform ACT 438.

The server can generate a HAVING clause (ACT 436). In an SQL operation, the HAVING clause can narrow data manipulation to one or more grouped rows (e.g., grouped by GROUP BY) in one or more tables in the data source based on conditions. For example, the HAVING clause can specify one or more conditions to include, access, or modify data. The HAVING clause can be appended to any SELECT, INSERT, UPDATE, or DELETE SQL statements that also include a GROUP BY clause. Based on the one or more conditions identified in ACT 434, the server can generate the HAVING clause for the final SQL query. The server can append the HAVING clause to the existing working query to further match the functionality of the original GraphQL operation received from the client device. After appending the HAVING clause to the query, the server can perform DECISION 438.

The server can determine whether to generate an ORDER BY clause (DECISION 438). In an SQL operation, the ORDER BY clause can order data records by sorting the selected data records (e.g., the result set of other SQL query operations) in either ascending or descending order. For example, the ORDER BY clause can cause the data records to be ordered based on sorting one or more columns in ascending or descending order. The GROUP BY clause can be appended to any SELECT, INSERT, UPDATE, or DELETE SQL statements. To determine whether the specified data source should include an ORDER BY clause, the server can access the one or more data structures in the memory of the server associated with the GraphQL query. The data structures can include information about one or more conditions associated with the respective GraphQL operation. The server can analyze the conditions present in the data structures (e.g., the update condition, the delete condition, the selection condition, etc.) to determine whether the ORDER BY clause is to be used for the final SQL query. The server can further parse and analyze the corresponding GraphQL operation to determine if there are any other conditions present that use an ORDER BY clause. If a condition exists that uses an ORDER BY clause, the server can perform ACT 440. If no condition exists for the GraphQL operation that uses an ORDER BY clause, the GraphQL operation can perform ACT 442.

The server can generate the ORDER BY clause (ACT 440). In an SQL operation, the ORDER BY clause can order data records by sorting the selected data records (e.g., the result set of other SQL query operations) in either ascending or descending order. For example, the ORDER BY clause can cause the data records to be ordered based on sorting one or more columns in ascending or descending order. The GROUP BY clause can be appended to any SELECT, INSERT, UPDATE, or DELETE SQL statements. Based on the one or more conditions identified in ACT 434, the server can generate the ORDER BY clause for the final SQL query. The server can append the ORDER BY clause to the existing working query to further match the functionality of the original GraphQL operation received from the client device. After appending the ORDER BY clause to the query, the server can perform DECISION 442.

The server can determine whether to generate a LIMIT clause (DECISION 442). In an SQL operation, the LIMIT clause can place an upper limit on the number of SQL tuples (e.g., data records) returned by SQL operations. For example, the LIMIT clause can narrow the number of requested data records based on a parameter value. If the parameter value is five, then only five data records can be returned from the SQL operation. By default, the LIMIT clause returns the first N values (where N is the number of returned data records) from the result set of the SQL operation. To add an offset to the limit, the OFFSET keyword can be used along with a parameter, to further narrow the range of values to be returned by the query. The LIMIT clause can be appended to a SELECT SQL statement. To determine whether the specified data source should include a LIMIT clause, the server can access the one or more data structures in the memory of the server associated with the GraphQL query. The data structures can include information about one or more conditions associated with the respective GraphQL operation. The server can analyze the conditions present in the data structures (e.g., the update condition, the delete condition, the selection condition, etc.) to determine whether the LIMIT clause is to be used for the final SQL query. The server can further parse and analyze the corresponding GraphQL operation to determine whether there are other conditions that use a LIMIT clause. If a condition exists that uses a LIMIT clause, the server can perform ACT 444. If no condition exists for the GraphQL operation that uses an ORDER BY clause, the GraphQL operation can perform ACT 446.

The server can generate the LIMIT clause (444). In an SQL operation, the LIMIT clause can place an upper limit on the number of SQL tuples (e.g., data records) returned by SQL operations. For example, the LIMIT clause can narrow the number of requested data records based on a parameter value. If the parameter value is five, then only five data records can be returned from the SQL operation. By default, the LIMIT clause returns the first N values (where N is the number of returned data records) from the result set of the SQL operation. To add an offset to the limit, the OFFSET keyword can be used along with a parameter, to further narrow the range of values to be returned by the query. The LIMIT clause can be appended to a SELECT SQL statement. Based on the one or more conditions identified in ACT 434, the server can generate the LIMIT clause for the final SQL query, including the one or more parameters or offsets. The server can append the LIMIT clause to the existing working query to further match the functionality of the original GraphQL operation received from the client device. After appending the LIMIT clause to the query, the server can perform ACT 446.

The server can generate the final SQL operation (ACT 446). The server has generated a large SQL query operation that may include one or more clauses. The server can finalize the large appended SQL query by determining whether there are any syntax or grammatical errors present. If there are any syntax or grammatical errors present, the server can modify the query to fix the one or more errors. In some implementations, the server can insert one or more temporary tags into the generated SQL query as placeholder values. Such placeholder values can take the place of data store specific information, such as table names, column names, and other parameter information that is not present in the GraphQL query, but is used to create the SQL query for the specified data source. After finalizing the SQL query, the server can perform ACT 448.

The server can combine the SQL query with a data source context (ACT 448). The data source context can include, for example, information from the schema file identified in ACT 402. The data source context can include information about tables, parameters, and other information used to create an SQL query operation to access the corresponding data source. Such information may not be included in the GraphQL query. Accordingly, the server can add the information included in the data source context to the generated SQL query, thus creating a query operation capable of operating on the data source. The server can then use the query to operate on the data source, and receive one or more SQL responses. After receiving one or more SQL responses, the server can perform ACT 450.

The server can generate a GraphQL response (ACT 450). The server can analyze the GraphQL operation to determine how to organize the data received from the data source in a GraphQL response. The GraphQL operation may include one or more SQL expressions, lambda functions, or user-defined functions. The server can apply such functions to the data in a post-processing step before generating the GraphQL response. In this way, the server can process the data in a way that may be unsupported by SQL query operations, or unsupported by the specified data source. To generate the GraphQL response, the server can allocate a region of memory for one or more data structures based on the GraphQL operation received from the client device. After allocating the memory, the server can access the SQL response data after post-processing, and place it in the allocated memory region to correspond to the GraphQL operation received from the client device. After generating the GraphQL response, the server can transmit, provide, or otherwise communicate the GraphQL response to the client device responsible for providing the GraphQL operation.

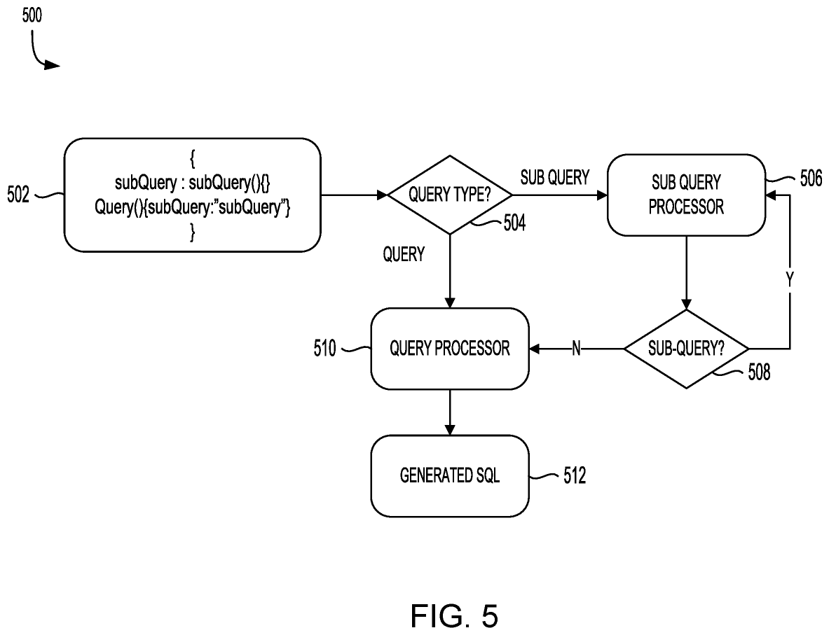

Referring now to FIG. 5, depicted is a method 500 for resolving one or more API query language sub-queries into an SQL operation. The method 500 can be performed by one or more system, component, or element depicted in FIG. 1A, 1B, 2, or 3, including, for example, the data processing system 205, the client device 220, the data source 215, or any other computing devices described herein. The server (e.g., the data processing system 205) can receive an API query language operation (e.g., a GraphQL query) including a sub-query (ACT 502). The server can determine whether the type of query includes a sub-query or only includes a query (DECISION 504). The server can provide the sub-query to the sub-query resolver (ACT 506). The server can determine whether there is an additional sub-query (DECISION 508). The server can provide the query to the query resolver (ACT 510). The server can generate the final SQL query operation (ACT 512).

The server (e.g., the data processing system 205) can receive an API query language operation (e.g., a GraphQL query) including a sub-query (ACT 502). The server can receive the API query language operation (e.g., a GraphQL query) from the client device. The API query language operation can include one or more sub-queries. Each sub-query of the sub-queries can define one or more API query language operations to roll-up data over a specified range. For example, an API query language operation can include one or more sub-queries to perform a roll-up operation over data in a data source over a specific data range, such as a time period. The API query language query can include one or more system fields that define the one or more sub-queries. Each of the system fields can include a label as an argument, for example “subQuery.” After receiving the API query language operation, the server can perform DECISION 504.

The server can determine whether the type of query includes a sub-query or only includes a query (DECISION 504). The API query language operation can include one or more sub-queries. The server can parse the API query language operation to enumerate each sub-query in the API query language operation to determine the number of queries present. For example, the server can identify each of the system fields with the name “subQuery,” or identify each system field that includes a label including “subQuery.” Before the server can process the overall API query language operation, the server can resolve each of the sub-queries included in the API query language operation. If the server identifies one or more sub-queries in the API query language operation, the server can perform ACT 506. If the server does not identify any sub-queries in the API query language operation, the server can perform ACT 510.

The server can provide the sub-query to the sub-query resolver (ACT 506). The server can iteratively process and resolve each sub-query in the API query language resolver. To process each sub-query, the server can process each sub-query as if it were an API language query operation using one or more query resolving rules as described above in conjunction with FIGS. 2 and 4A-B. From the enumerated list of sub-queries identified in ACT 504, the server can select the first un-resolved sub-query, and process the sub-query as if it were an API language query operation to generate an SQL query operation. The server can store the SQL query operation corresponding to the sub-query in one or more data structures in the memory of the server. After processing the first un-processed sub-query, the server can perform DECISION 508.

The server can determine whether there is an additional sub-query (DECISION 508). After processing a sub-query, the server can determine whether there are any remaining resolved sub-queries in the API query language operation. For example, the server can access one or more data structures in the memory of the server to determine whether there are SQL operations generated for each of the sub-queries enumerated for the API query language operation. If there are no additional sub-queries present, the server can perform ACT 510. If there are additional unresolved sub-queries present in the API query language operation, the server can identify the first unresolved sub-query and perform ACT 506.

The server can provide the query to the query resolver (ACT 510). After all sub-queries in the API query language operation, the server can resolve the top level API query language operation. The top level API query language operation can include operations performed on the data records returned by the sub-queries. Each of the labels of the sub-queries are added to the top level query in this stage, and an initial SQL operation for the API language query operation is generated including sub-query identifiers (e.g., one or more labels). After generating the initial API language query operation including the sub-query identifiers, the server can perform ACT 512.

The server can generate the final SQL query operation (ACT 512). The server can finalize the SQL query operation corresponding to the API query language operation by including one or more clauses, and incorporating each sub-query corresponding to each sub-query identifier inserted in ACT 510. For example, the top level API query language operation may perform conditional operations that use one or more SQL clauses on the data records returned by the one or more sub-queries. The server can generate a top level SQL operation, corresponding to the syntax compatible with the specified data source, to include each SQL sub-query and each clause to implement the functionality of the API query language operation received from the client device. For example, the final SQL query operation can include WHERE, GROUP BY, HAVING, ORDER BY or LIMIT clauses that operate on the data sets returned by each sub-query. The server can nest each sub-query corresponding to the sub-query identifiers inside the top level query to generate a final top level-query that includes all sub-queries and top level query operations. The server can then provide the top level SQL query operation to the specified data source, as described above in conjunction with FIGS. 2 and 4A-B.

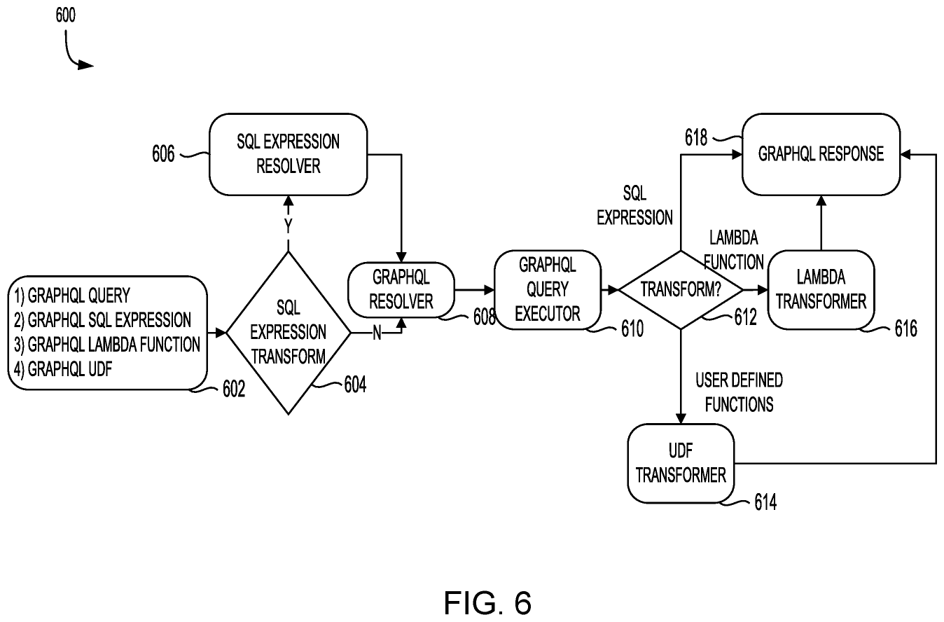

Referring now to FIG. 6, depicted is a flow diagram of a method 600 for transforming functions and expressions in an API query language operation. The method 600 can be performed by one or more system, component, or element depicted in FIG. 1A, 1B, 2, or 3, including, for example, the data processing system 205, the client device 220, the data source 215, or any other computing devices described herein. The server (e.g., the data processing system 205) can receive an API query language operation including an SQL expression, a lambda function, or a user-defined function (ACT 602). The server can determine whether the API query language operation includes an SQL expression transform (DECISION 604). The server can resolve the SQL expression (ACT 606). The server can resolve the SQL query (ACT 608). The server can execute the API query language operation (ACT 610). The server can determine whether the API query language operation included an SQL expression transform, a lambda function transform, or a user-defined function (UDF) transform (DECISION 612). The server can transform the UDF on the SQL response (ACT 614). The server can transform the lambda function on the SQL response (ACT 616). The server can generate the API query language response (ACT 618).

The server (e.g., the data processing system 205) can receive an API query language operation (e.g., a GraphQL query or mutation) including an SQL expression, a lambda function, or a user-defined function (ACT 602). The server can receive the API query language operation from a client device (e.g., the client device 220). For example, the API query language operation may include one or more SQL expressions to operate on the data records returned by the data source. The API query language operation can include one or more lambda functions to transform the data records returned by the data source. The API query language operation can include one or more user-defined functions that can perform functionality that goes beyond the capabilities of both SQL expressions and lambda functions. User-defined functions and lambda functions can operations that may be unsupported by the data source, thereby extending the functionality of the data source by providing additional data transformation functionality. After receiving the API query language operation, the server can perform DECISION 604.

The server can determine whether the API query language operation includes an SQL expression transform (DECISION 604). The server can parse the API query language operation to determine whether there are any SQL expressions present in the QPI query language operation. For example, if the API query language operation is a GraphQL query, the GraphQL query can include an input argument for one or more SQL expressions. The SQL expression can support all of the SQL functions that the specified data source can support. If the server determines that the API query language operation includes one or more SQL expressions, the server can perform ACT 606. If the server determines that the API query language operation does not include one or more SQL expressions, the server can perform ACT 608.

The server can resolve the SQL expression (ACT 606). If the API query language operation includes one or more SQL expressions, the server can resolve the portion of the API query language operation that specifies the SQL expression into an SQL query operation that corresponds to the SQL expression. The resolved SQL query operation can include a SELECT clause that can be transformed or resolved in accordance with the API query language operation. The SQL expression can be transformed or resolved, for example, using the system and methods described herein above in conjunction with FIGS. 2 and 4A-B. If more than one SQL expression is present in the API query language operation, the server can resolve each of the SQL expressions. After transforming or resolving the SQL expression of the API query language operation, the server can perform ACT 608.

The server can resolve the SQL query (ACT 608). The server can resolve the top level API query language operation. The server can resolve the API query language operation in accordance with the systems and methods described herein above in conjunction with FIGS. 2 and 4A-B to generate an SQL query that corresponds to the API query language operation. If one or more SQL expressions were present in the API query language operation, the server can combine the generated SQL expression queries with the generated top-level SQL query to create a final SQL top-level query. If one or more lambda functions or user-defined functions are present in the API query language operation, the server can extract each of the lambda functions and user-defined functions from the API query language operation before resolving the API query language operation into a top-level SQL query. The server can store any extracted user-defined functions or lambda functions in one or more data structures in the memory of the server. The server can index the one or more data structures, for example, by an identifier corresponding to the API query language operation received from the client device. After resolving the API query language operation, the server can perform ACT 610.

The server can execute the API query language operation (ACT 610). The server can execute the API query language operation by transmitting the API query language operation to the data source specified by the API query language operation. The client device that provided the API query language operation can specify the data source. One or more schema files identified by the server to resolve the API query language operation can specify the data source. The server can transmit the resolved SQL query, which can include one or more resolved SQL expressions, to the specified data source to receive an SQL response. The SQL response can include one or more data records, or one or more indications of successful operations. The SQL response can include one or more error messages, error codes, or other error information. After receiving the SQL response from the data source, the server can perform DECISION 612.

The server can determine whether the API query language operation included an SQL expression transform, a lambda function transform, or a user-defined function (UDF) transform (DECISION 612). The server can access one or more data structures associated with the API query language operation to determine whether the API query language operation included any lambda functions or user-defined functions. If the API query language operation did not include any lambda operations, user-defined operations, or SQL expressions, the server can perform ACT 618. If the API query language operation included a user-defined function, the server can perform ACT 614. If the API query language operation included a lambda function, the server can perform ACT 616. If the API query language operation included one or more SQL expressions, but did not include any lambda functions or user-defined functions, the server can perform ACT 618.

The server can transform the UDF on the SQL response (ACT 614). User-defined functions can include advanced transformations that may not fit into standard lambda functions. Such user-defined functions can include the application of different transformations to meet one or more requirements specified by the API query language operations. The server can parse the user-defined functions extracted from the API query language operation in ACT 608, and capture one or more instructions to transform the data returned in the SQL response from the data source. The server can recursively apply the one or more instructions to transform the data included in the SQL response to generate a transformed SQL response. The server can recursively apply the one or more instructions parsed from each user-defined function specified in the API query language operation. After the user-defined functions specified in the API query language operation have been applied to the data records included in the SQL response returned from the data source, the server can perform ACT 618.

The server can transform the lambda function on the SQL response (ACT 616). To determine the lambda functions to apply to the data records included in the SQL response, the server can access one or more data structures associated with the API query language response. The server can retrieve one or more lambda functions from the data structures stored in the memory of the server. The server can decode the lambda function argument included in the API query language operation to determine which lambda functions to apply to the data records included in the API query language operations. The server can then apply the identified lambda functions to the data records included in the SQL response from the data source to generate a transformed SQL response. If additional user-defined functions are included in the API query language operation, the server can perform ACT 614. After generating the transformed SQL response, the server can perform ACT 618.

The server can generate the API query language response (ACT 618). The server can access the data records received in the SQL response to generate the API query language response. The server can transmit the API query language response the client device that provided the API query language operation. If the server has generated a transformed SQL response, the server can access the data records in the transformed SQL response instead of the data records in the SQL response to generate the API query language response. The API query language response can be generated in accordance with the systems and methods described above in conjunction with FIGS. 2 and 4A-B.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

It will be further understood that various changes in the details, materials, and arrangements of the parts that have been described and illustrated herein may be made by those skilled in the art without departing from the scope of the following claims.

We claim:

1. A method of executing an operation on a data source, comprising:
receiving, by a server from a client device, a request specifying an application programming interface (“API”) query language operation to execute on a data source having a structured query language (“SQL”) application programming interface;
identifying, by the server, a schema file for operation of the API query language on the data source having the SQL API;
translating, by the server, the API query language operation into an SQL operation using the API query language schema file configured for the data source;
transmitting, by the server, the SQL operation to the data source;
receiving, by the server, an SQL response to the SQL operation from the data source; and
generating, by the server, an API query language response based on the SQL response from the data source that is responsive to the request from the client device specifying the API query language operation.

2. The method of claim 1, wherein the API query language is a graph query language (“GraphQL”), comprising:
determining, by the server, a type of the API query language operation is query; and
building, by the server, responsive to determining the type of API query language operation is query, a plurality of clauses based on the API query language schema file to generate the SQL operation comprising at least one of a selection set, a where clause, a group by clause, an order by clause, a limit clause, or a having clause.

3. The method of claim 1, comprising:
determining, by the server, a type of the API query language operation is mutation create;
identifying, by the server, an input object and a target table corresponding to the request; and
generating, by the server, the SQL operation based on the input object and the target table using one or more extensions in the API query language schema file.

4. The method of claim 1, comprising:
determining, by the server, a type of the API query language operation is mutation update;
identifying an update input and an update condition corresponding to a where clause of the API query language operation to selectively update one or more records of the data source; and
generating, by the server, the SQL operation based on the update input, the update condition, and a target table using one or more extensions in the API query language schema file.

5. The method of claim 1, comprising:
determining, by the server, a type of the API query language operation is mutation delete;
identifying a delete condition corresponding to a where clause of the API query language operation to selectively delete one or more records of the data source; and
generating, by the server, the SQL operation based on the delete condition and a target table using one or more extensions in the API query language schema file.

6. The method of claim 1, wherein the API query language schema file defines a dialect or a domain-specific language of the data source.

7. The method of claim 1, comprising:
translating the API query language operation to the SQL operation using clauses of the API query language operation comprising at least one of where, orderBy, groupBy, or limit.

8. The method of claim 1, comprising:
determining the request for the API query language operation comprises an API query language argument that defines an SQL expression; and
processing the SQL response based on the SQL expression to generate the API query language response.

9. The method of claim 1, comprising:
determining the request for the API query language operation comprises a lambda function argument configured to apply a transformation on a collections of objects stored in the data source; and
processing the SQL response based on the lambda function argument to generate the API query language response.

10. The method of claim 1, comprising:
performing a roll up of the API query language operation by generating one or more sub-SQL operations for the SQL operation to aggregate data from the data source.

11. A system to execute an operation on a data source, comprising:
an server comprising one or more processors and memory configured to:
receive, from a client device, a request specifying an application programming interface (“API”) query language operation to execute on a data source having a structured query language (“SQL”) application programming interface;
identify a schema file for operation of the API query language on the data source having the SQL API;
translate the API query language operation into an SQL operation using the API query language schema file configured for the data source;
transmit the SQL operation to the data source;
receive an SQL response to the SQL operation from the data source; and
generate an API query language response based on the SQL response from the data source that is responsive to the request from the client device specifying the API query language operation.

12. The system of claim 11, wherein the server is configured to:
determine a type of the API query language operation is query; and
create, responsive to determining the type of API query language operation is query, a plurality of clauses based on the API query language schema file to generate the SQL operation comprising at least one of a selection set, a where clause, a group by clause, an order by clause, a limit clause, or a having clause.

13. The system of claim 11, wherein the server is configured to:
determine a type of the API query language operation is mutation create;
identify an input object and a target table corresponding to the request; and
generate the SQL operation based on the input object and the target table using one or more extensions in the API query language schema file.

14. The system of claim 11, wherein the server is configured to:
determine a type of the API query language operation is mutation update;
identify an update input and an update condition corresponding to a where clause of the API query language operation to selectively update one or more records of the data source; and
generate the SQL operation based on the update input, the update condition, and a target table using one or more extensions in the API query language schema file.

15. The system of claim 11, wherein the server is configured to:
determine a type of the API query language operation is mutation delete;
identify a delete condition corresponding to a where clause of the API query language operation to selectively delete one or more records of the data source; and
generate the SQL operation based on the delete condition and a target table using one or more extensions in the API query language schema file.

16. The system of claim 11, wherein the API query language schema file defines a dialect or a domain-specific language of the data source.

17. The system of claim 11, wherein the server is configured to:
translate the API query language operation to the SQL operation using clauses of the API query language operation comprising at least one of where, orderBy, groupBy, or limit.

18. The system of claim 11, wherein the server is configured to:
determine the request for the API query language operation comprises an API query language argument that defines an SQL expression; and
process the SQL response based on the SQL expression to generate the API query language response.

19. A non-transitory computer readable medium storing program instructions for causing one or more processors to:
receive, from a client device, a request specifying an application programming interface (“API”) query language operation to execute on a data source having a structured query language (“SQL”) application programming interface;
identify a schema file for operation of the API query language on the data source having the SQL API;
translate the API query language operation into an SQL operation using the API query language schema file configured for the data source;
transmit the SQL operation to the data source;
receive an SQL response to the SQL operation from the data source; and
generate an API query language response based on the SQL response from the data source that is responsive to the request from the client device specifying the API query language operation.

20. The non-transitory computer readable medium of claim 19, wherein the program instructions further cause the one or more processors to:
determine a type of the API query language operation is query; and
create, responsive to determining the type of API query language operation is query, a plurality of clauses based on the API query language schema file to generate the SQL operation comprising at least one of a selection set, a where clause, a group by clause, an order by clause, a limit clause, or a having clause.
